(19) United States
(12) Patent Application Publication
(10) Pub. No.: US 2023/0308411 A1
(43) Pub. Date: Sep. 28, 2023

(54) RELATIONSHIP-AGNOSTIC MESSAGING SYSTEM

(71) Applicant: Snap Inc., Santa Monica, CA (US)

(72) Inventors: Yuanchen Bai, Bellevue, WA (US); Nathan Kenneth Boyd, Los Angeles, CA (US); Benjamin Ralph Hollis, Seattle, WA (US); Vinay Kola, Seattle, WA (US); Qi Li, Bellevue, WA (US); Ketan Sethi, Los Angeles, CA (US); Wade Spires, Santa Monica, CA (US); Susan Marie Territo, Los Angeles, CA (US); Jeremy Baker Voss, Los Angeles, CA (US); Yu Wang, Mill Valley, CA (US); Aleksandr Zhang, Seattle, WA (US)

(21) Appl. No.: 18/125,491

(22) Filed: Mar. 23, 2023

Related U.S. Application Data
(60) Provisional application No. 63/323,905, filed on Mar. 25, 2022.

(51) Int. Cl. H04L 51/52; G06Q 50/00

(52) U.S. Cl. CPC H04L 51/52; G06Q 50/01

(57) ABSTRACT

In some examples, a method includes maintaining first electronic contact data for a plurality of users of an interaction system, and relationship data relating to relationships between the plurality of users. The method also includes, using the first electronic contact data and the relationship data, automatically generating composite electronic contact data. The composite electronic contact data includes a first electronic contact record for a first user with which a specific user has a relationship as reflected in the relationship data, and a second electronic contact record for a second user with which the specific user has no relationship as reflected in the relationship data. The composite electronic contact data is presented within the interaction system in a manner that visually distinguishes between the first electronic contact record and the second electronic contact record. The specific user is enabled to initiate an electronic interaction with the second user.

### CLAIM OF PRIORITY

This application claims the benefit of priority to U.S. Provisional Application Ser. No. 63/323,905, filed on Mar. 25, 2022, which is incorporated herein by reference in its entirety.

### TECHNICAL FIELD

The present disclosure relates generally to interaction systems and, more particularly, to relationship-agnostic messaging in an interaction system.

### BACKGROUND

The popularity of electronic messaging continues to grow. Users increasingly share messages including text and/or media content items such as electronic images and videos with each other. Users also increasingly utilize mobile devices to communicate with each other using various interaction systems that include messaging functionality (also referred to as chat functionality) suitable for sharing such messages.

A first user of an interaction system may wish to interact with a second user, but the interaction system may prevent the first user from doing so due to the lack of an existing bidirectional relationship between the two users (also referred to as a friend relationship, in some examples). For example, the first user may be unable to send a message to, or share certain content with, the second user unless a friend relationship has been established in the records of the interaction system. A friend relationship may be established by an offer from the first user to the second user to establish a friend relationship, and acceptance by the second user of the offer for establishment of the friend relationship (or vice versa). Limitations of this nature may create technical hurdles preventing certain electronic interactions between users.

### BRIEF DESCRIPTION OF THE SEVERAL VIEWS OF THE DRAWINGS

In the drawings, which are not necessarily drawn to scale, like numerals may describe similar components in different views. To identify the discussion of any particular element or act more easily, the most significant digit or digits in a reference number refer to the figure number in which that element is first introduced. Some non-limiting examples are illustrated in the figures of the accompanying drawings in which:

FIG. 1 is a diagrammatic representation of a networked environment in which the present disclosure may be deployed, according to some examples.

FIG. 2 is a diagrammatic representation of an interaction system, according to some examples, that has both client-side and server-side functionality.

FIG. 3 is a diagrammatic representation of a data structure as maintained in a database, according to some examples.

FIG. 4 is a relationship diagram showing details regarding various data structures and interactions in and with an interaction system, according to some examples.

FIG. 5 is a flowchart illustrating a method, according to some examples, to facilitate messaging or other interactions between entities of an interaction system.

FIG. 6 is a set of user interface diagrams showing messaging user interfaces in the form of sender and recipient user interfaces, according to some examples.

FIG. 7 is a user interface diagram illustrating a header zone of a messaging user interface, according to some examples.

FIG. 8 is a user interface diagram illustrating a header zone of a messaging user interface, according to some examples.

FIG. 9 is a user interface sequence diagram illustrating a search interface and a messaging user interface, according to some examples, with the search interface being partially shown.

FIG. 10 is a user interface diagram illustrating an alert notification, according to some examples.

FIG. 11 is a user interface sequence diagram, illustrating a message feed interface, a view in which an action sheet is overlaid onto the message feed interface, and a view in which a confirmation sheet is overlaid onto the message feed interface, respectively.

FIG. 12 is a user interface diagram illustrating part of a user profile interface, according to some examples.

FIG. 13 is a user interface diagram illustrating part of a user profile interface, according to some examples.

FIG. 14 is a user interface diagram illustrating an action sheet overlaid onto a user profile interface, according to some examples.

FIG. 15 is a user interface sequence diagram illustrating a message feed interface and an alert notification overlaid onto the message feed interface, according to some examples.

FIG. 16 is a user interface diagram showing a recipient user interface, according to some examples.

FIG. 17 is a user interface diagram illustrating a contact settings interface, according to some examples.

FIG. 18 is a user interface diagram illustrating a user profile interface, according to some examples.

FIG. 19 is a user interface diagram illustrating a conversation creation interface, according to some examples.

FIG. 20 is a user interface diagram illustrating a message feed interface including recommendations, according to some examples.

FIG. 21 is a user interface diagram illustrating a message feed interface including recommendations, according to some examples.

FIG. 22 is a user interface diagram showing a sender user interface, according to some examples.

FIG. 23 is a diagrammatic representation of a message, according to some examples.

FIG. 24 is a flowchart for an access-limiting process, according to some examples.

FIG. 25 illustrates a head-wearable apparatus, according to some examples.

FIG. 26 is a block diagram showing a software architecture within which examples may be implemented.

FIG. 27 is a diagrammatic representation of a machine in the form of a computer system within which a set of instructions may be executed for causing the machine to perform any one or more of the methodologies discussed herein, according to some examples.

### DETAILED DESCRIPTION

Example interaction systems enable users to avoid waiting for friend request approval to interact with others. In some examples, existing users of an interaction system can interact with people in their electronic contact book (e.g., provided by a contact management application on a mobile device) without having to commit to a bidirectional relationship (e.g., “friendship”) upfront. Interacting with users may involve sharing messages or other content, such as map locations.

A user profile interface may be modified or supplemented to provide details of a connection between two users, e.g., to indicate to an active user that another user is in their electronic contact book, even though the other user is not recorded as their friend in the interaction system. An example technical problem of a user being unable to interact, or restricted from certain interactions, due to the lack of an existing (direct) relationship in the interaction system, can accordingly be addressed or alleviated through relationship-agnostic messaging functionality.

Example interaction systems perform a matching operation between records of user relationships in the interaction system and other user relationship records, such as a user's electronic contact book records. A composite list of contacts may be generated for a subject user, including users having a direct (e.g., bidirectional) relationship with the subject user in the interaction system and users not having such a (direct) relationship. A composite list of contact identifiers can then be presented to the subject user. In some examples, a feed interface of the subject user is automatically updated to surface contact information and/or messages from other users not holding a bidirectional relationship with the subject user. A contact presentation process may include visually distinguishing presentation of an electronic contact identifier of a user holding a bidirectional relationship with an active user, and a user not holding such a bidirectional relationship with the active user. An example technical problem of improving the efficiency or intuitiveness of an interaction system may accordingly be addressed or alleviated.

The technical problem of improving the efficiency or intuitiveness of an interaction system is further addressed or alleviated, in some examples, through a recommendation engine that identifies users to present to an active user as “recommended friends.” Such recommendations may be surfaced in a feed interface, enabling the active user to interact with the recommended users more easily and without having to wait for friend request approval. These recommendations may be dynamically generated, causing automatic updating of the feed interface.

Additionally, example methods and systems described herein provide various technological functions and safeguards that, while permitting relationship-agnostic messaging on a limited basis, ensure that a receiving user can conveniently accept or decline messages from a sending user, and specify protections and privacy.

When the effects in this disclosure are considered in aggregate, one or more of the methodologies described herein may improve known systems, providing additional functionality (such as, but not limited to, the functionality mentioned above), making them easier, faster, or more intuitive to operate, and/or obviating a need for certain efforts or resources that otherwise would be involved in an electronic interaction process. Computing resources used by one or more machines, databases, or networks may thus be more efficiently utilized or even reduced.

Networked Computing Environment

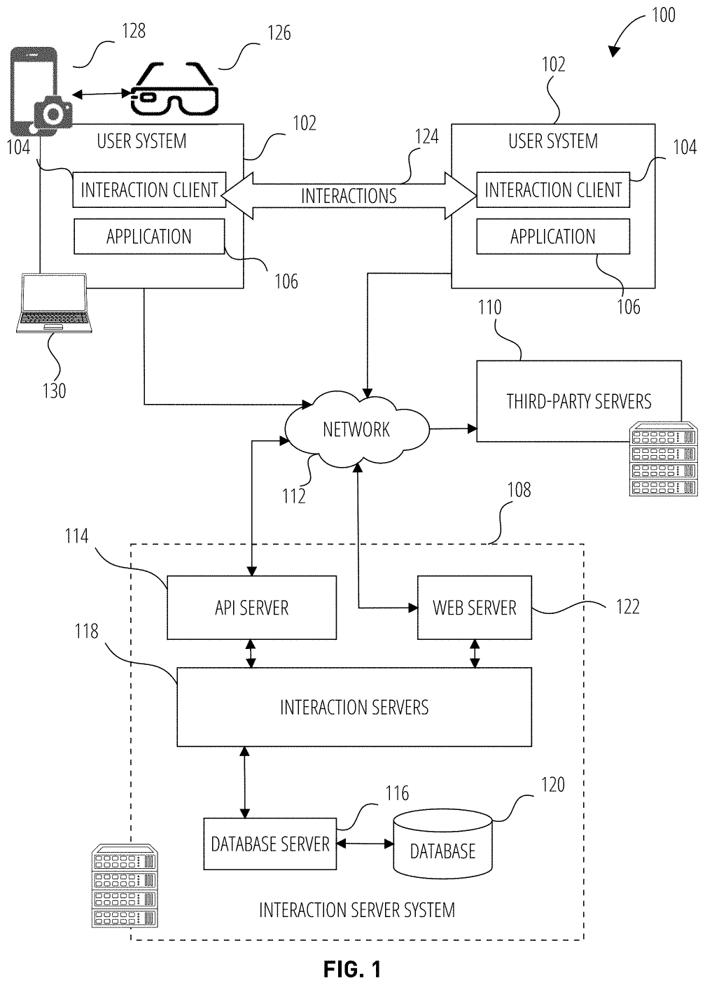

FIG. 1 is a block diagram showing an example interaction system 100 for facilitating interactions (e.g., exchanging text messages, conducting text, audio and video calls, or playing games) over a network. The interaction system 100 includes multiple user systems 102, each of which hosts multiple applications, including an interaction client 104 and other applications 106. Each interaction client 104 is communicatively coupled, via one or more communication networks including a network 112 (e.g., the Internet), to other instances of the interaction client 104 (e.g., hosted on respective other user system 102), an interaction server system 108 and third-party servers 110). An interaction client 104 can also communicate with locally hosted applications 106 using Applications Program Interfaces (APIs).

Each user system 102 may include multiple user devices, such as a mobile device 128, head-wearable apparatus 126, and a computer client device 130 that are communicatively connected to exchange data and messages. An interaction client 104 interacts with other interaction clients 104 and with the interaction server system 108 via the network 112. The data exchanged between the interaction clients 104 (e.g., interactions 124) and between the interaction clients 104 and the interaction server system 108 includes functions (e.g., commands to invoke functions) and payload data (e.g., text, audio, video, or other multimedia data).

The interaction server system 108 provides server-side functionality via the network 112 to the interaction clients 104. While certain functions of the interaction system 100 are described herein as being performed by either an interaction client 104 or by the interaction server system 108, the location of certain functionality either within the interaction client 104 or the interaction server system 108 may be a design choice. For example, it may be technically preferable to initially deploy particular technology and functionality within the interaction server system 108 but to later migrate this technology and functionality to the interaction client 104 where a user system 102 has sufficient processing capacity.

The interaction server system 108 supports various services and operations that are provided to the interaction clients 104. Such operations include transmitting data to, receiving data from, and processing data generated by the interaction clients 104. This data may include message content, client device information, geolocation information, media augmentation and overlays, message content persistence conditions, entity relationship information, and live event information. Data exchanges within the interaction system 100 are invoked and controlled through functions available via user interfaces (UIs) of the interaction clients 104.

Turning now specifically to the interaction server system 108, an API server 114 is coupled to and provides programmatic interfaces to interaction servers 118, making the functions of the interaction servers 118 accessible to interaction clients 104, other applications 106 and third-party servers 110. The interaction servers 118 are communicatively coupled to a database server 116, facilitating access to a database 120 that stores data associated with interactions processed by the interaction servers 118. Similarly, a web server 122 is coupled to the interaction servers 118 and provides web-based interfaces to the interaction servers 118. To this end, the web server 122 processes incoming network requests over the Hypertext Transfer Protocol (HTTP) and several other related protocols.

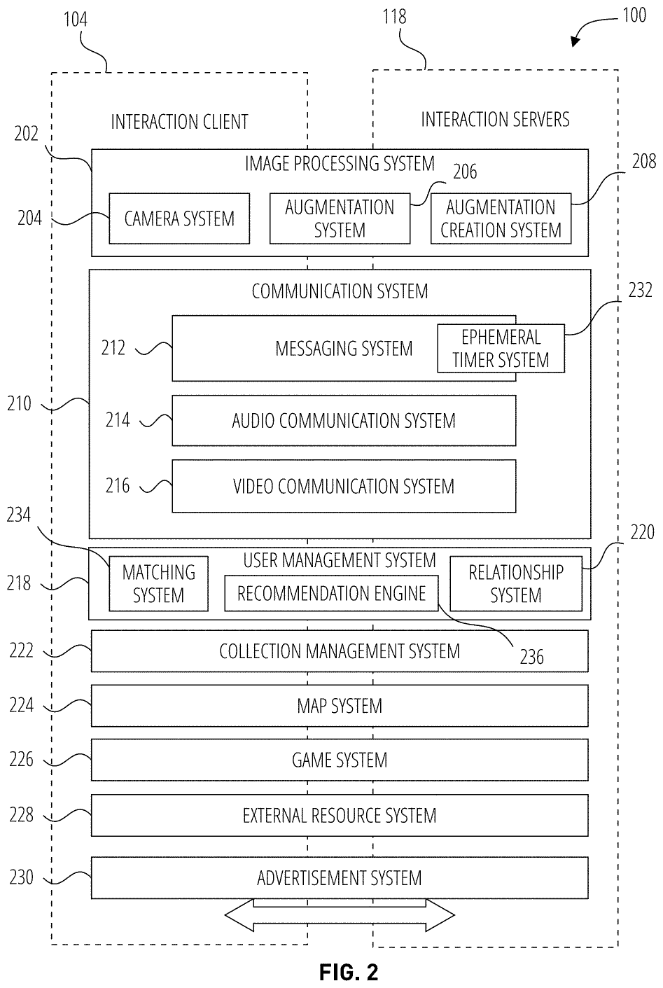

The API server 114 receives and transmits interaction data (e.g., commands and message payloads) between the interaction servers 118 and the user systems 102 (and for example, interaction clients 104 and other application 106) and the third-party servers 110. Specifically, the API server 114 provides a set of interfaces (e.g., routines and protocols) that can be called or queried by the interaction client 104 and other applications 106 to invoke functionality of the interaction servers 118. The API server 114 exposes various functions supported by the interaction servers 118, including account registration, login functionality, the sending of interaction data via the interaction servers 118, from a particular interaction client 104 to another interaction client 104, the communication of media files (e.g., images or video) from an interaction client 104 to the interaction servers 118, the settings of a collection of media data (e.g., a story), the retrieval of a list of friends (or other related users) of a user of a user system 102, the retrieval of messages and content, the addition and deletion of entities (e.g., friends) to an entity graph (e.g., a social graph), the location of friends within a social graph, and opening an application event (e.g., relating to the interaction client 104). The interaction servers 118 host multiple systems and subsystems, described below with reference to FIG. 2.

Linked Applications

Returning to the interaction client 104, features and functions of an external resource (e.g., a linked application 106 or applet) are made available to a user via an interface of the interaction client 104. In this context, “external” refers to the fact that the application 106 or applet is external to the interaction client 104. The external resource is often provided by a third party but may also be provided by the creator or provider of the interaction client 104. The interaction client 104 receives a user selection of an option to launch or access features of such an external resource. The external resource may be the application 106 installed on the user system 102 (e.g., a “native app”), or a small-scale version of the application (e.g., an “applet”) that is hosted on the user system 102 or remote of the user system 102 (e.g., on third-party servers 110). The small-scale version of the application includes a subset of features and functions of the application (e.g., the full-scale, native version of the application) and is implemented using a markup-language document. In some examples, the small-scale version of the application (e.g., an “applet”) is a web-based, markup-language version of the application and is embedded in the interaction client 104. In addition to using markup-language documents (e.g., a .*ml file), an applet may incorporate a scripting language (e.g., a .*js file or a .json file) and a style sheet (e.g., a .*ss file).

In response to receiving a user selection of the option to launch or access features of the external resource, the interaction client 104 determines whether the selected external resource is a web-based external resource or a locally-installed application 106. In some cases, applications 106 that are locally installed on the user system 102 can be launched independently of and separately from the interaction client 104, such as by selecting an icon, corresponding to the application 106 on a home screen of the user system 102. Small-scale versions of such applications can be launched or accessed via the interaction client 104 and, in some examples, no or limited portions of the small-scale application can be accessed outside of the interaction client 104. The small-scale application can be launched by the interaction client 104 receiving from a third-party servers 110, for example, a markup-language document associated with the small-scale application and processing such a document.

In response to determining that the external resource is a locally-installed application 106, the interaction client 104 instructs the user system 102 to launch the external resource by executing locally-stored code corresponding to the external resource. In response to determining that the external resource is a web-based resource, the interaction client 104 communicates with the third-party servers 110 (for example) to obtain a markup-language document corresponding to the selected external resource. The interaction client 104 then processes the obtained markup-language document to present the web-based external resource within a user interface of the interaction client 104.

The interaction client 104 can notify a user of the user system 102, or other users related to such a user (e.g., “friends”), of activity taking place in one or more external resources. For example, the interaction client 104 can provide participants in a conversation (e.g., a chat session) in the interaction client 104 with notifications relating to the current or recent use of an external resource by one or more members of a group of users. One or more users can be invited to join in an active external resource or to launch a recently-used but currently inactive (in the group of friends) external resource. The external resource can provide participants in a conversation, each using respective interaction clients 104, with the ability to share an item, status, state, or location in an external resource with one or more members of a group of users into a chat session. The shared item may be an interactive chat card with which members of the chat can interact, for example, to launch the corresponding external resource, view specific information within the external resource, or take the member of the chat to a specific location or state within the external resource. Within a given external resource, response messages can be sent to users on the interaction client 104. The external resource can selectively include different media items in the responses, based on a current context of the external resource.

The interaction client 104 can present a list of the available external resources (e.g., applications 106 or applets) to a user to launch or access a given external resource. This list can be presented in a context-sensitive menu. For example, the icons representing different ones of the application 106 (or applets) can vary based on how the menu is launched by the user (e.g., from a conversation interface or from a non-conversation interface).

System Architecture

FIG. 2 is a block diagram illustrating further details regarding the interaction system 100, according to some examples. Specifically, the interaction system 100 is shown to comprise the interaction client 104 and the interaction servers 118. The interaction system 100 embodies multiple subsystems, which are supported on the client-side by the interaction client 104 and on the server-side by the interaction servers 118.

An image processing system 202 provides various functions that enable a user to capture and augment (e.g., annotate or otherwise modify or edit) media content associated with a message. A camera system 204 includes control software (e.g., in a camera application) that interacts and controls camera hardware (e.g., directly or via operating system controls) of the user system 102 to modify and augment real-time images captured and displayed via the interaction client 104.

The augmentation system 206 provides functions related to the generation and publishing of augmentations (e.g., media overlays) for images captured in real-time by cameras of the user system 102 or retrieved from memory of the user system 102. For example, the augmentation system 206 operatively selects, presents, and displays media overlays (e.g., an image filter or an image lens) to the interaction client 104 for the augmentation of real-time images received via the camera system 204 or stored images retrieved from memory 2524 of a user system 102. These augmentations are selected by the augmentation system 206 and presented to a user of an interaction client 104, based on a number of inputs and data, such as for example:
Geolocation of the user system 102; and
Entity relationship information of the user of the user system 102.

An augmentation may include audio and visual content and visual effects. Examples of audio and visual content include pictures, texts, logos, animations, and sound effects. An example of a visual effect includes color overlaying. The audio and visual content or the visual effects can be applied to a media content item (e.g., a photo or video) at user system 102 for communication in a message, or applied to video content, such as a video content stream or feed transmitted from an interaction client 104. As such, the image processing system 202 may interact with, and support, the various subsystems of the communication system 210, such as the messaging system 212 and the video communication system 216.

A media overlay may include text or image data that can be overlaid on top of a photograph taken by the user system 102 or a video stream produced by the user system 102. In some examples, the media overlay may be a location overlay (e.g., Venice beach), a name of a live event, or a name of a merchant overlay (e.g., Beach Coffee House). In further examples, the image processing system 202 uses the geolocation of the user system 102 to identify a media overlay that includes the name of a merchant at the geolocation of the user system 102. The media overlay may include other indicia associated with the merchant. The media overlays may be stored in the databases 120 and accessed through the database server 116.

The image processing system 202 provides a user-based publication platform that enables users to select a geolocation on a map and upload content associated with the selected geolocation. The user may also specify circumstances under which a particular media overlay should be offered to other users. The image processing system 202 generates a media overlay that includes the uploaded content and associates the uploaded content with the selected geolocation.

The augmentation creation system 208 supports augmented reality (AR) developer platforms and includes an application for content creators (e.g., artists and developers) to create and publish augmentations (e.g., augmented reality experiences) of the interaction client 104. The augmentation creation system 208 provides a library of built-in features and tools including, for example custom shaders, tracking technology, templates, to content creators.

In some examples, the augmentation creation system 208 provides a merchant-based publication platform that enables merchants to select a particular augmentation associated with a geolocation via a bidding process. For example, the augmentation creation system 208 associates a media overlay of the highest bidding merchant with a corresponding geolocation for a predefined amount of time.

A communication system 210 is responsible for enabling and processing multiple forms of communication and interaction within the interaction system 100 and includes a messaging system 212, an audio communication system 214, and a video communication system 216. The messaging system 212 is responsible for enforcing the temporary or time-limited access to content by the interaction clients 104. The messaging system 212 incorporates multiple timers (e.g., within an ephemeral timer system 232) that, based on duration and display parameters associated with a message, or collection of messages (e.g., a story), selectively enable access (e.g., for presentation and display) to messages and associated content via the interaction client 104. Further details regarding the operation of the ephemeral timer system 232 are provided below. The audio communication system 214 enables and supports audio communications (e.g., real-time audio chat) between multiple interaction clients 104. Similarly, the video communication system 216 enables and supports video communications (e.g., real-time video chat) between multiple interaction clients 104.

A user management system 218 is operationally responsible for the management of user data and profiles, and includes an entity relationship system 220 that maintains information regarding relationships between users of the interaction system 100. The user management system 218 may be responsible for recording relationship data, performing matching operations as described herein, e.g., using a matching system 234, generating combined contact data and commingled contact lists as described herein, and/or generating “friend” or “contact” identifiers and recommendations for presentation to an active user. The user management system 218 may further include a recommendation engine 236 configured to recommend, to a specific user, other users of the interaction system 100 to interact with and/or establish relationships with. For example, the recommendation engine 236 may be configured to detect, for a specific user, that the specific user and another user has more than a predetermined number of mutual “friends.” Based on such a determination, the user management system 218 may cause a recommendation to be transmitted or presented to the specific user, suggesting that the specific user add the other user as a friend, or the like, and/or that the specific user interact with the other user (e.g., send a message to the other user) without necessarily first requesting a “friend” relationship, as described further below.

A collection management system 222 is operationally responsible for managing sets or collections of media (e.g., collections of text, image video, and audio data). A collection of content (e.g., messages, including images, video, text, and audio) may be organized into an “event gallery” or an “event story.” Such a collection may be made available for a specified time period, such as the duration of an event to which the content relates. For example, content relating to a music concert may be made available as a “story” for the duration of that music concert. The collection management system 222 may also be responsible for publishing an icon that provides notification of a particular collection to the user interface of the interaction client 104. The collection management system 222 includes a curation function that allows a collection manager to manage and curate a particular collection of content. For example, the curation interface enables an event organizer to curate a collection of content relating to a specific event (e.g., delete inappropriate content or redundant messages). Additionally, the collection management system 222 employs machine vision (or image recognition technology) and content rules to curate a content collection automatically. In certain examples, compensation may be paid to a user to include user-generated content into a collection. In such cases, the collection management system 222 operates to automatically make payments to such users to use their content.

A map system 224 provides various geographic location functions, and supports the presentation of map-based media content and messages by the interaction client 104. For example, the map system 224 enables the display of user icons or avatars (e.g., stored in profile data 316) on a map to indicate a current or past location of “friends” of a user, as well as media content (e.g., collections of messages including photographs and videos) generated by such friends, within the context of a map. For example, a message posted by a user to the interaction system 100 from a specific geographic location may be displayed within the context of a map at that particular location to “friends” of a specific user on a map interface of the interaction client 104. A user can furthermore share his or her location and status information (e.g., using an appropriate status avatar) with other users of the interaction system 100 via the interaction client 104, with this location and status information being similarly displayed within the context of a map interface of the interaction client 104 to selected users.

A game system 226 provides various gaming functions within the context of the interaction client 104. The interaction client 104 provides a game interface providing a list of available games that can be launched by a user within the context of the interaction client 104 and played with other users of the interaction system 100. The interaction system 100 further enables a particular user to invite other users to participate in the play of a specific game by issuing invitations to such other users from the interaction client 104. The interaction client 104 also supports audio, video, and text messaging (e.g., chats) within the context of gameplay, provides a leaderboard for the games, and also supports the provision of in-game rewards (e.g., coins and items).

An external resource system 228 provides an interface for the interaction client 104 to communicate with remote servers (e.g., third-party servers 110) to launch or access external resources, i.e., applications or applets. Each third-party server 110 hosts, for example, a markup language (e.g., HTML5) based application or a small-scale version of an application (e.g., game, utility, payment, or ride-sharing application). The interaction client 104 may launch a web-based resource (e.g., application) by accessing the HTML5 file from the third-party servers 110 associated with the web-based resource. Applications hosted by third-party servers 110 are programmed in JavaScript leveraging a Software Development Kit (SDK) provided by the interaction servers 118. The SDK includes Application Programming Interfaces (APIs) with functions that can be called or invoked by the web-based application. The interaction servers 118 host a JavaScript library that provides a given external resource access to specific user data of the interaction client 104. HTML5 is an example of technology for programming games, but applications and resources programmed based on other technologies can be used.

To integrate the functions of the SDK into the web-based resource, the SDK is downloaded by a third-party servers 110 from the interaction servers 118 or is otherwise received by the third-party servers 110. Once downloaded or received, the SDK is included as part of the application code of a web-based external resource. The code of the web-based resource can then call or invoke certain functions of the SDK to integrate features of the interaction client 104 into the web-based resource.

The SDK stored on the interaction server system 108 effectively provides the bridge between an external resource (e.g., applications 106 or applets and the interaction client 104. This gives the user a seamless experience of communicating with other users on the interaction client 104 while also preserving the look and feel of the interaction client 104. To bridge communications between an external resource and an interaction client 104, the SDK facilitates communication between third-party servers 110 and the interaction client 104. A Web ViewJavaScriptBridge running on a user system 102 establishes two one-way communication channels between an external resource and the interaction client 104. Messages are sent between the external resource and the interaction client 104 via these communication channels asynchronously. Each SDK function invocation is sent as a message and callback. Each SDK function is implemented by constructing a unique callback identifier and sending a message with that callback identifier.

By using the SDK, not all information from the interaction client 104 is shared with third-party servers 110. The SDK limits which information is shared based on the needs of the external resource. Each third-party server 110 provides an HTML5 file corresponding to the web-based external resource to interaction servers 118. The interaction servers 118 can add a visual representation (such as a box art or other graphic) of the web-based external resource in the interaction client 104. Once the user selects the visual representation or instructs the interaction client 104 through a GUI of the interaction client 104 to access features of the web-based external resource, the interaction client 104 obtains the HTML5 file and instantiates the resources to access the features of the web-based external resource.

The interaction client 104 presents a graphical user interface (e.g., a landing page or title screen) for an external resource. During, before, or after presenting the landing page or title screen, the interaction client 104 determines whether the launched external resource has been previously authorized to access user data of the interaction client 104. In response to determining that the launched external resource has been previously authorized to access user data of the interaction client 104, the interaction client 104 presents another graphical user interface of the external resource that includes functions and features of the external resource. In response to determining that the launched external resource has not been previously authorized to access user data of the interaction client 104, after a threshold period of time (e.g., 3 seconds) of displaying the landing page or title screen of the external resource, the interaction client 104 slides up (e.g., animates a menu as surfacing from a bottom of the screen to a middle of or other portion of the screen) a menu for authorizing the external resource to access the user data. The menu identifies the type of user data that the external resource will be authorized to use. In response to receiving a user selection of an accept option, the interaction client 104 adds the external resource to a list of authorized external resources and allows the external resource to access user data from the interaction client 104. The external resource is authorized by the interaction client 104 to access the user data under an OAuth 2 framework.

The interaction client 104 controls the type of user data that is shared with external resources based on the type of external resource being authorized. For example, external resources that include full-scale applications (e.g., an application 106) are provided with access to a first type of user data (e.g., two-dimensional avatars of users with or without different avatar characteristics). As another example, external resources that include small-scale versions of applications (e.g., web-based versions of applications) are provided with access to a second type of user data (e.g., payment information, two-dimensional avatars of users, three-dimensional avatars of users, and avatars with various avatar characteristics). Avatar characteristics include different ways to customize a look and feel of an avatar, such as different poses, facial features, clothing, and so forth. An advertisement system 230 operationally enables the purchasing of advertisements by third parties for presentation to end-users via the interaction clients 104 and also handles the delivery and presentation of these advertisements.

Data Architecture

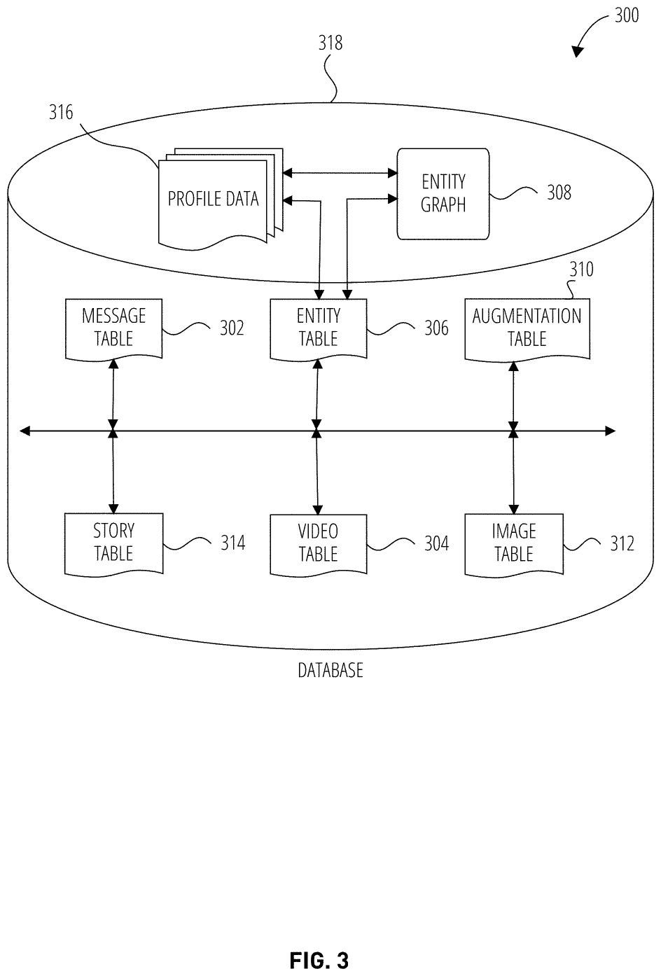

FIG. 3 is a schematic diagram illustrating data structures 300, which may be stored in the database 318 of the interaction server system 108, according to certain examples. While the content of the database 318 is shown to comprise multiple tables, it will be appreciated that the data could be stored in other types of data structures (e.g., as an object-oriented database).

The database 318 includes message data stored within a message table 302. This message data includes, for any particular message, at least message sender data, message recipient (or receiver) data, and a payload. Further details regarding information that may be included in a message, and included within the message data stored in the message table 302 is described below with reference to FIG. 3.

An entity table 306 stores entity data, and is linked (e.g., referentially) to an entity graph 308 and profile data 316. Entities for which records are maintained within the entity table 306 may include individuals, corporate entities, organizations, objects, places, events, and so forth. Regardless of entity type, any entity regarding which the interaction server system 108 stores data may be a recognized entity. Each entity is provided with a unique identifier, as well as an entity type identifier.

The entity graph 308 stores information regarding relationships and associations between entities. Such relationships may be social, professional (e.g., work at a common corporation or organization), interest-based, or activity-based, merely for example. One type of social relationship is a friend relationship, which is established by mutual agreement between two entities. This mutual agreement may be established by an offer from a first entity to a second entity to establish a friend relationship, and acceptance by the second entity of the offer for establishment of the friend relationship.

The profile data 316 stores multiple types of profile data about a particular entity. The profile data 316 may be selectively used and presented to other users of the interaction system 100, based on privacy settings specified by a particular entity. Where the entity is an individual, the profile data 316 includes, for example, a username, telephone number, address, settings (e.g., notification and privacy settings), as well as a user-selected avatar representation (or collection of such avatar representations). A particular user may then selectively include one or more of these avatar representations within the content of messages communicated via the interaction system 100, and on map interfaces displayed by interaction clients 104 to other users. The collection of avatar representations may include “status avatars,” which present a graphical representation of a status or activity that the user may select to communicate at a particular time.

Where the entity is a group, the profile data 316 for the group may similarly include one or more avatar representations associated with the group, in addition to the group name, members, and various settings (e.g., notifications) for the relevant group.

The database 318 also stores augmentation data, such as overlays or filters, in an augmentation table 310. The augmentation data is associated with and applied to videos (for which data is stored in a video table 304) and images (for which data is stored in an image table 312).

Filters, in some examples, are overlays that are displayed as overlaid on an image or video during presentation to a recipient user. Filters may be of various types, including user-selected filters from a set of filters presented to a sending user by the interaction client 104, when the sending user is composing a message. Other types of filters include geolocation filters (also known as geo-filters), which may be presented to a sending user based on geographic location. For example, geolocation filters specific to a neighborhood or special location may be presented within a user interface by the interaction client 104, based on geolocation information determined by a Global Positioning System (GPS) unit of the user system 102.

Another type of filter is a data filter, which may be selectively presented to a sending user by the interaction client 104, based on other inputs or information gathered by the user system 102 during the message creation process. Examples of data filters include current temperature at a specific location, a current speed at which a sending user is traveling, battery life for a user system 102, or the current time. Other augmentation data that may be stored within the image table 312 includes augmented reality content items (e.g., corresponding to applying Lenses or augmented reality experiences). An augmented reality content item may be a real-time special effect and sound that may be added to an image or a video.

As described above, augmentation data includes augmented reality content items, overlays, image transformations, AR images, and similar terms refer to modifications that may be applied to image data (e.g., videos or images). This includes real-time modifications, which modify an image as it is captured using device sensors (e.g., one or multiple cameras) of the user system 102 and then displayed on a screen of the user system 102 with the modifications. This also includes modifications to stored content, such as video clips in a collection or group that may be modified. For example, in a user system 102 with access to multiple augmented reality content items, a user can use a single video clip with multiple augmented reality content items to see how the different augmented reality content items will modify the stored clip. Similarly, real-time video capture may use modifications to show how video images currently being captured by sensors of a user system 102 would modify the captured data. Such data may simply be displayed on the screen and not stored in memory, or the content captured by the device sensors may be recorded and stored in memory with or without the modifications (or both). In some systems, a preview feature can show how different augmented reality content items will look within different windows in a display at the same time. This can, for example, enable multiple windows with different pseudo random animations to be viewed on a display at the same time.

Data and various systems using augmented reality content items or other such transform systems to modify content using this data can thus involve detection of objects (e.g., faces, hands, bodies, cats, dogs, surfaces, objects, etc.), tracking of such objects as they leave, enter, and move around the field of view in video frames, and the modification or transformation of such objects as they are tracked. In various examples, different methods for achieving such transformations may be used. Some examples may involve generating a three-dimensional mesh model of the object or objects, and using transformations and animated textures of the model within the video to achieve the transformation. In some examples, tracking of points on an object may be used to place an image or texture (which may be two-dimensional or three-dimensional) at the tracked position. In still further examples, neural network analysis of video frames may be used to place images, models, or textures in content (e.g., images or frames of video). Augmented reality content items thus refer both to the images, models, and textures used to create transformations in content, as well as to additional modeling and analysis information needed to achieve such transformations with object detection, tracking, and placement.

Real-time video processing can be performed with any kind of video data (e.g., video streams, video files, etc.) saved in a memory of a computerized system of any kind. For example, a user can load video files and save them in a memory of a device, or can generate a video stream using sensors of the device. Additionally, any objects can be processed using a computer animation model, such as a human's face and parts of a human body, animals, or non-living things such as chairs, cars, or other objects.

In some examples, when a particular modification is selected along with content to be transformed, elements to be transformed are identified by the computing device, and then detected and tracked if they are present in the frames of the video. The elements of the object are modified according to the request for modification, thus transforming the frames of the video stream. Transformation of frames of a video stream can be performed by different methods for different kinds of transformation. For example, for transformations of frames mostly referring to changing forms of object's elements characteristic points for each element of an object are calculated (e.g., using an Active Shape Model (ASM) or other known methods). Then, a mesh based on the characteristic points is generated for each element of the object. This mesh is used in the following stage of tracking the elements of the object in the video stream. In the process of tracking, the mesh for each element is aligned with a position of each element. Then, additional points are generated on the mesh.

In some examples, transformations changing some areas of an object using its elements can be performed by calculating characteristic points for each element of an object and generating a mesh based on the calculated characteristic points. Points are generated on the mesh, and then various areas based on the points are generated. The elements of the object are then tracked by aligning the area for each element with a position for each of the at least one element, and properties of the areas can be modified based on the request for modification, thus transforming the frames of the video stream. Depending on the specific request for modification properties of the mentioned areas can be transformed in different ways. Such modifications may involve changing the color of areas; removing some part of areas from the frames of the video stream; including new objects into areas that are based on a request for modification; and modifying or distorting the elements of an area or object. In various examples, any combination of such modifications or other similar modifications may be used. For certain models to be animated, some characteristic points can be selected as control points to be used in determining the entire state-space of options for the model animation.

In some examples of a computer animation model to transform image data using face detection, the face is detected on an image using a specific face detection algorithm (e.g., Viola-Jones). Then, an Active Shape Model (ASM) algorithm is applied to the face region of an image to detect facial feature reference points.

Other methods and algorithms suitable for face detection can be used. For example, in some examples, features are located using a landmark, which represents a distinguishable point present in most of the images under consideration. For facial landmarks, for example, the location of the left eye pupil may be used. If an initial landmark is not identifiable (e.g., if a person has an eyepatch), secondary landmarks may be used. Such landmark identification procedures may be used for any such objects. In some examples, a set of landmarks forms a shape. Shapes can be represented as vectors using the coordinates of the points in the shape. One shape is aligned to another with a similarity transform (allowing translation, scaling, and rotation) that minimizes the average Euclidean distance between shape points. The mean shape is the mean of the aligned training shapes.

A transformation system can capture an image or video stream on a client device (e.g., the user system 102) and perform complex image manipulations locally on the user system 102 while maintaining a suitable user experience, computation time, and power consumption. The complex image manipulations may include size and shape changes, emotion transfers (e.g., changing a face from a frown to a smile), state transfers (e.g., aging a subject, reducing apparent age, changing gender), style transfers, graphical element application, and any other suitable image or video manipulation implemented by a convolutional neural network that has been configured to execute efficiently on the user system 102.

In some examples, a computer animation model to transform image data can be used by a system where a user may capture an image or video stream of the user (e.g., a selfie) using the user system 102 having a neural network operating as part of an interaction client 104 operating on the user system 102. The transformation system operating within the interaction client 104 determines the presence of a face within the image or video stream and provides modification icons associated with a computer animation model to transform image data, or the computer animation model can be present as associated with an interface described herein. The modification icons include changes that are the basis for modifying the user's face within the image or video stream as part of the modification operation. Once a modification icon is selected, the transform system initiates a process to convert the image of the user to reflect the selected modification icon (e.g., generate a smiling face on the user). A modified image or video stream may be presented in a graphical user interface displayed on the user system 102 as soon as the image or video stream is captured and a specified modification is selected. The transformation system may implement a complex convolutional neural network on a portion of the image or video stream to generate and apply the selected modification. That is, the user may capture the image or video stream and be presented with a modified result in real-time or near real-time once a modification icon has been selected. Further, the modification may be persistent while the video stream is being captured, and the selected modification icon remains toggled. Machine-taught neural networks may be used to enable such modifications.

The graphical user interface, presenting the modification performed by the transform system, may supply the user with additional interaction options. Such options may be based on the interface used to initiate the content capture and selection of a particular computer animation model (e.g., initiation from a content creator user interface). In various examples, a modification may be persistent after an initial selection of a modification icon. The user may toggle the modification on or off by tapping or otherwise selecting the face being modified by the transformation system and store it for later viewing or browsing to other areas of the imaging application. Where multiple faces are modified by the transformation system, the user may toggle the modification on or off globally by tapping or selecting a single face modified and displayed within a graphical user interface. In some examples, individual faces, among a group of multiple faces, may be individually modified, or such modifications may be individually toggled by tapping or selecting the individual face or a series of individual faces displayed within the graphical user interface.

A story table 314 stores data regarding collections of messages and associated image, video, or audio data, which are compiled into a collection (e.g., a story or a gallery). The creation of a particular collection may be initiated by a particular user (e.g., each user for which a record is maintained in the entity table 306). A user may create a “personal story” in the form of a collection of content that has been created and sent/broadcast by that user. To this end, the user interface of the interaction client 104 may include an icon that is user-selectable to enable a sending user to add specific content to his or her personal story.

A collection may also constitute a “live story,” which is a collection of content from multiple users that is created manually, automatically, or using a combination of manual and automatic techniques. For example, a “live story” may constitute a curated stream of user-submitted content from various locations and events. Users whose client devices have location services enabled and are at a common location event at a particular time may, for example, be presented with an option, via a user interface of the interaction client 104, to contribute content to a particular live story. The live story may be identified to the user by the interaction client 104, based on his or her location. The end result is a “live story” told from a community perspective.

A further type of content collection is known as a “location story,” which enables a user whose user system 102 is located within a specific geographic location (e.g., on a college or university campus) to contribute to a particular collection. In some examples, a contribution to a location story may require a second degree of authentication to verify that the end-user belongs to a specific organization or other entity (e.g., is a student on the university campus).

As mentioned above, the video table 304 stores video data that, in some examples, is associated with messages for which records are maintained within the message table 302. Similarly, the image table 312 stores image data associated with messages for which message data is stored in the entity table 306. The entity table 306 may associate various augmentations from the augmentation table 310 with various images and videos stored in the image table 312 and the video table 304.

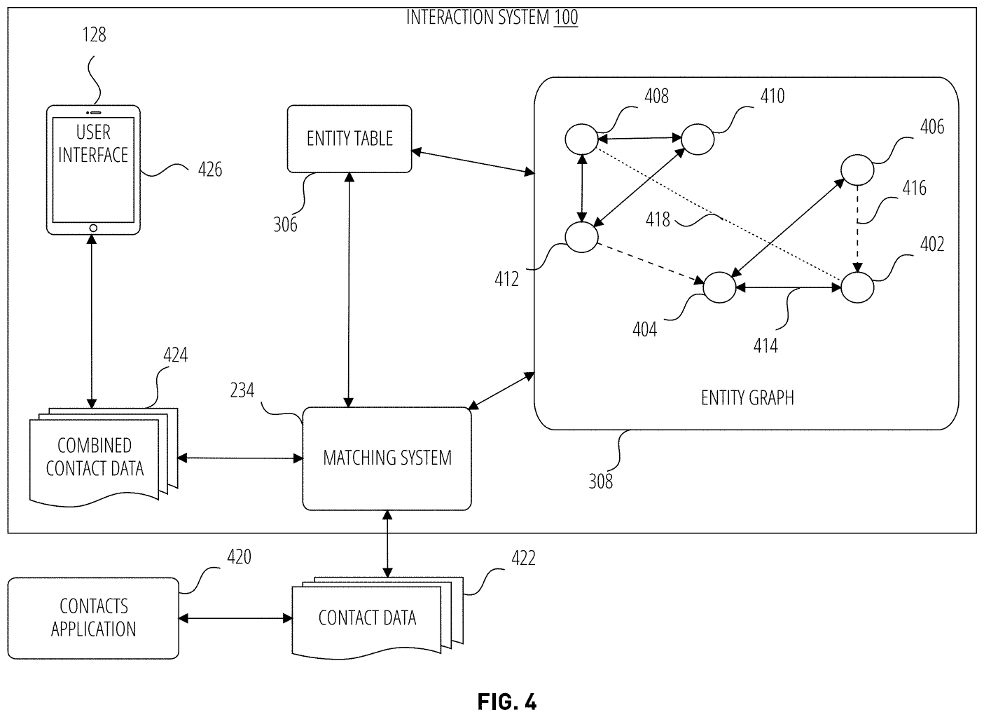

FIG. 4 is a relationship diagram, showing further details regarding various data structures and interactions in and with the interaction system 100 shown in FIG. 1, according to some examples. As described with reference to FIG. 3, the interaction system 100 maintains an entity table 306 of data or records for entities (e.g., registered users) of the interaction system 100, as well as an entity graph 308, which stores the details of relationships between these various entities. FIG. 4 shows further details of relationships between example entities in the form of users of the interaction system 100. These relationships are recorded as relationship data stored within the databases 120 of the interaction server system 108.

The entity graph 308 shows a user 402 having a bidirectional relationship 414 with user 404, a one-directional relationship 416 with user 406, and no direct relationship 418 with user 408. Various other bidirectional and one-directional relationships between users 402, 404, 406, 408, 410 and 412 are also reflected to illustrate the entity graph 308 according to some examples.

A one-directional relationship, such as the one-directional relationship 416 between the user 402 and the user 406 may result from the user 406 sending a relationship request (e.g., a request to add the user 406 as a friend) to the user 402. As the user 402 may not have accepted that relationship request yet, the relationship is regarded as a one-directional relationship 416, in some examples. On the other hand, the user 402 has a bidirectional relationship with the user 404, because of, in some examples, one of these parties having extended an invitation to a relationship to the other, and the other having accepted that invitation to establish the bidirectional relationship 414.

As a result of the establishment of a relationship, as recorded with the entity graph 308 as a one-directional or a bidirectional relationship, certain automated information sharing may occur within the context of the interaction system 100 as a result of the establishment of that relationship. For example, where the interaction system 100 comprises an entity relationship system, such as a social media system, information, data and/or content relating to one entity (e.g., the user 402) may be shared according to the direction of the relationship. Where a one-directional relationship exists, information, data and/or content may be shared in the direction of that relationship. Where a bidirectional relationship exists, information, data and/or content sharing may be mutual and occur in both directions between the entities. Where interaction system 100 includes an entity relationship system, such as a social media system, shared information may include, for example, content that has been generated or shared by a user, geolocation information regarding the user, and certain profile or personal information. As part of a bidirectional relationship, the interaction system 100 may thus automatically share user-generated content and/or other data between the two users in the relationship, that would not be shared in the absence of such a relationship.

Privacy settings and systems provided by the interaction system 100 and any particular entity, such as the user 402, may specify which information is shared under each of a one-directional relationship or a bidirectional relationship with other entities. Privacy settings may also determine the type and extent of information shared, depending upon a classification, by the relevant entity, of the relationship type with another entity.

While permissions are granted by an entity, such as the user 402, in terms of communications within the context of the interaction system 100, there are described herein systems and methodologies to enable a user to initiate communications with another user. Absent the establishment of a one-directional or bidirectional relationship between those entities (this may be regarded as the absence of a direct relationship), for example, the described methods and systems enable the user 402 to send a message to the user 408, with which the user 402 has no established relationship. Additionally, the methods and systems provide various technological functions and safeguards that, while permitting messaging on a limited basis, ensure that a receiving user (e.g., the user 408) can conveniently accept or decline the messages and also specify protections and privacy. The described methods and systems also enable the sending user 402 conveniently to locate a desired receiving user 408, and conveniently extend an invitation for a bidirectional relationship 414 (e.g., a “friend” relationship) within the context of the interaction system 100.

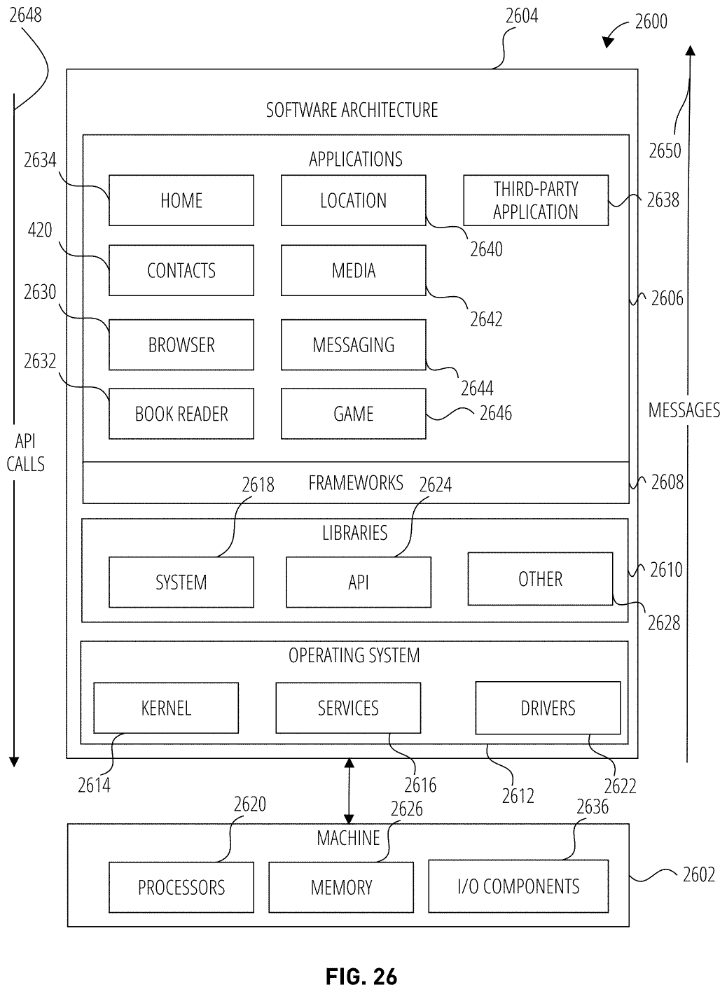

It will be appreciated that a user system 102, in addition to hosting the interaction client 104, may host a number of further applications 106. Examples of such applications are described with respect to FIG. 26, for example, as the applications 2606. One such application may be a contact management application in the form of contacts application 420 (other examples may include a third-party communication application, such as a third-party messaging application or a third-party email application, and a third-party social media platform application). The contacts application 420 maintains a set of electronic contact data 422 that may be accessible by a matching system that is associated with or forms part of an interaction system. FIG. 4 shows a matching system in the example form of matching system 234, forming part of the interaction system 100.

The interaction system 100 maintains its own set of contact information as stored within the entity table 306 and the entity graph 308. Accordingly, the entity data stored within the entity table 306 and the entity graph 308 may be viewed as a first set or collection of electronic contact data, and contact data stored by an external application, such as the contact data 422 maintained by the contacts application 420, may be viewed as a second set of electronic contact data. FIG. 4 illustrates that the matching system 234 has access to both of these first and second sets of electronic contact data, in that the matching system 234 has access to the entity table 306, the entity graph 308, as well as the contact data 422 of the external contacts application 420. The matching system 234 operatively accesses both the first set of contact data and the second set of contact data to generate combined contact data 424, which is made available to the interaction system 100. The interaction system 100 may then supplement and present the combined contact data 424, within various user interfaces presented by the interaction client 104, e.g., the user interface 426 shown in FIG. 4 as being presented on the mobile device 128 of FIG. 1. The combined contact data 424, or identifiers linked to the combined contact data 424, may be presented in the example form of a commingled list, as described herein.

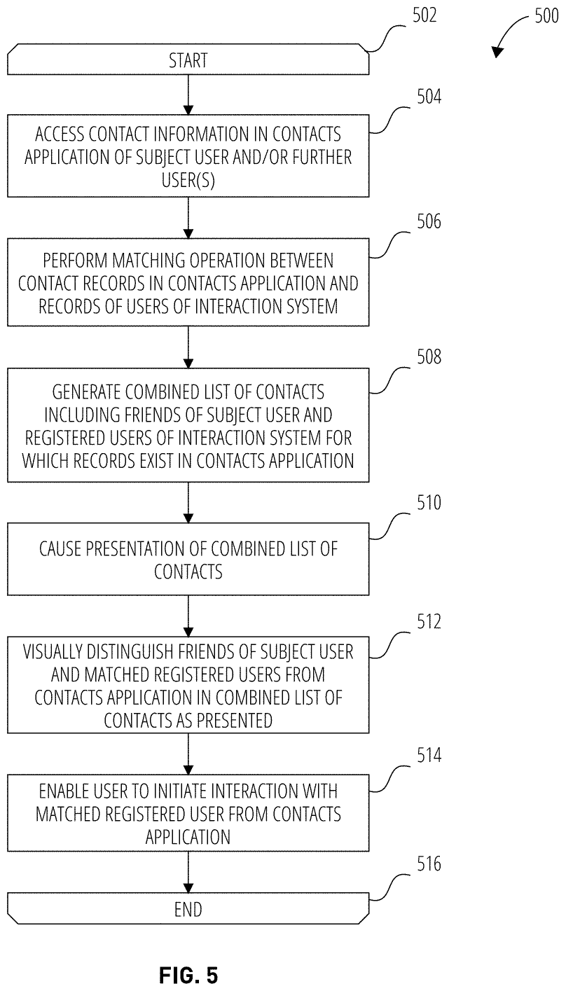

FIG. 5 is a flowchart illustrating a method 500, according to some examples, to facilitate messaging or other interactions between entities of an interaction system 100. For example, the method 500 may be used to enable the user 402, despite having no direct relationship 418 with the user 408, to perform an interaction with the user 408 (e.g., receive a message from and/or send a message to the user 408).

The method 500 starts at block 502, and proceeds to block 504, where the matching system 234 accesses a third-party application in the example form of the contacts application 420 and associated contact data 422 (e.g., within an address book) maintained by the contacts application 420, of a particular user (referred to as the subject user). The interaction system 100 may also access contacts applications 420 and the contact data 422 of multiple further users of the interaction system 100. To this end, with appropriate permissions and in accordance with privacy settings of such multiple further users, the interaction system 100 may request access to and access third-party applications and associated contact data 422 of multiple devices for multiple users of the interaction system 100.

At block 506, the matching system 234 performs a matching operation between the contact data 422 and users of the interaction system 100. For example, the matching system 234 may perform a matching operation between records within the contact data 422 and records within the entity table 306 to identify corresponding records. In order to perform the matching, the matching system 234 may examine and compare various types of information included in the contact data 422, including email addresses, telephone numbers, names, geographic location information, etc. In addition to identifying matched entities, the matching system 234, at block 506, also retrieves relationship data relating to matched entities, for example, indicating whether another user has no direct relationship, a one-directional relationship, or a bidirectional relationship with a subject user.

At block 508, the matching system 234 then generates a composite list of contacts for the subject user (combined contact data 424), which includes further users having a relationship (bidirectional, and optionally also one-directional) with the subject user, as well as further users of the interaction system 100 for which matched records exist within the contact data 422 (e.g., contacts application 420) of the subject user. Matched records may exist as a result of such further users being included in contact data 422 of the subject user, or the subject user being included in the contact data 422 of the further users, or combinations thereof. In addition to generating the combined list of contacts that includes friends of the subject user and registered users of the interaction system 100 for which matching records exist, the method 500 may include, at block 508, obtaining details of “non-users” of the interaction system 100, e.g., a user identified by contact information that has not been used to register with the interaction system 100, but that has been found in the contacts application 420 of the subject user. This set of “non-users” may be added to a commingled list of contact identifiers, as described in more detail below, to facilitate on-boarding of the non-users with the interaction system 100, e.g., by allowing the subject user to invite a non-user to register (using the details found in the contact management application) and participate in the interaction system 100.

The matching system 234 communicates the combined contact data 424 to the interaction system 100, which then, at block 510, causes presentation of the combined contact data 424 in a user interface 426, for example, within a search user interface 902 or a new chat interface 1902, as a commingled list of contact identifiers (e.g., names and digital avatars). As mentioned above, details of non-users may be added to this commingled list, in some examples, to provide the subject user with a convenient option for inviting those non-users to the interaction system 100. These may be seen as “friend recommendations”, as the subject user may utilize the presented details of non-users (e.g., phone numbers from an address book) to invite one or more of the non-users to join the interaction system 100.

At block 512, users with which a subject user has a relationship (e.g., “friends” of the subject user) are visually distinguished, within the presented combined contact data 424, from users with which the subject user has no relationship, as reflected in the entity graph 308. This visual distinguishing may include presenting text that identifies whether or not a user has a relationship with the subject user (e.g., is a “friend”) of the subject user. As mentioned, non-users may also be presented as “friend recommendations” and these non-users may be visually distinguished from other users (e.g., by an “invite” button or presentation in an “invite” section in a user interface). In addition, the combined contact data 424 may include other users, with which the subject user has a relationship, or even other users, located by a particular search query, but with which the subject user has no relationship, and which do not appear in the contact data (e.g., address book) of the subject user (or vice versa). Again, users or identifiers in the presented list may be visually distinguished from each other based on the type of relationship with the subject user (or lack thereof) or in the case of a non-user, whether the identifier corresponds to a registered user of the interaction system 100.

At block 514, the interaction system 100, via the interaction client 104, enables a subject user to initiate an interaction with a further user of the interaction system 100, e.g., to interact with a matched registered user of the interaction system 100 who appears in the subject user's contacts application 420 but does not have a direct relationship with the subject user in the interaction system 100. The further user may appear in the contact data 422 of the third-party application (e.g., the contacts application 420), or may be a user of the interaction system 100, located as a result of a search, but with which the subject user has no existing relationship and whose information does not appear in the contact data 422. The interaction client 104 may also enable the further user to initiate the interaction. In this way, the method 500 facilitates ease of communication between users that may not have an established and recorded relationship in the context of interaction system 100.

The enabling of the subject user to initiate an interaction with a further user with which no relationship exists (or enabling the further user to initiate the interaction) may be facilitated and enabled in various ways described herein. For example, various user-selectable indicia may be presented within messaging interfaces that enable a subject user to send a message and concurrently and conveniently send a request to a further user to establish a bidirectional relationship with the subject user. The establishment of such a bidirectional relationship within the interaction system 100 may include soliciting and receiving permission from the further user for the establishment of such a relationship. The establishment of such a bidirectional relationship then enables, as described herein, the automatic sharing of specific or predetermined data or information between the users, depending on the relationship type and privacy/permission settings of the respective users. The method 500 terminates at block 516.

Examples seek to address technical hurdles to interactions between users of the interaction system 100, by enabling messages and/or other interactions between users without requiring the prior establishment of a bidirectional relationship (e.g., a friend relationship) between the relevant users.

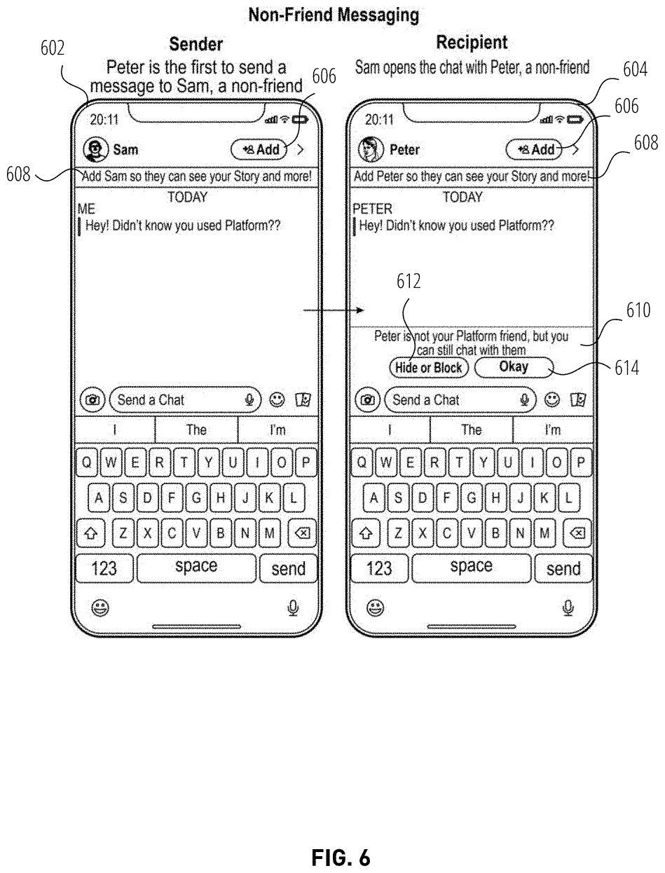

FIG. 6 is a user interface diagram showing messaging user interfaces in the form of example sender and recipient user interfaces (sender user interface 602 and recipient user interface 604) as presented by the interaction client 104, according to some examples, to a user of the interaction system 100. In FIG. 6, the sender sends a message to a non-friend using the sender user interface 602 and the recipient receives the message as shown in the recipient user interface 604. The sender and recipient user interfaces 602 and 604 illustrate conversation views presented by the interaction client 104.

When a user, using the interaction client 104, opens a conversation with a non-friend in either the sender user interface 602 or the recipient user interface 604, an add button 606 is presented within a header section of the relevant user interface and a description bar 608 is attached to the header with text that explains why the user might want to add this friend, e.g., “Add [FIRST NAME] so they can see your Story and more!” The add button 606 is an example of a relationship establishing graphical element that is user-selectable, by a specific user, to invite a second user to establish a bidirectional relationship with the specific user within a context of the interaction system 100.

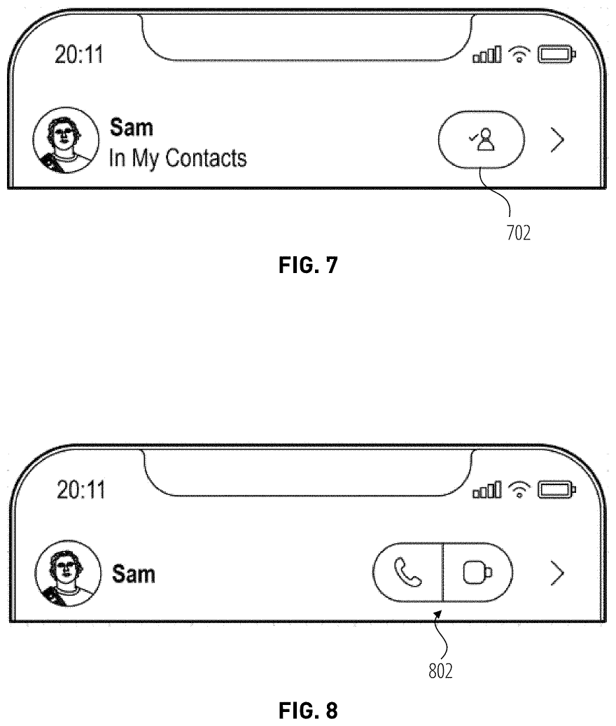

As is shown in FIG. 7, once a user initiates establishment of a bidirectional social relationship (e.g., requests a friend relationship), the text in the description bar 608 is removed to make room for any relevant friend activity subtext, and a friend addition indicator 702 is displayed in the header to indicate that the subject user has “added” the other user (establishing a one-directional relationship).

In some examples, A user can send messages that will appear to be delivered on a sender message feed, but sending a message is not a guarantee of a conversation being presented on the feed of the recipient. For example, recipient-side privacy may be governed by the recipient's privacy settings (e.g., “Who Can Contact Me?” settings, which is described with reference to examples below). Once the other user has accepted the request and a bidirectional relationship is established, the friend addition indicator 702 is removed and a set of calling buttons 802 is presented in the header, as shown in FIG. 8. These calling buttons 802 represent calling options that were unavailable before, but become available as a result of the bidirectional relationship established between the users.

Returning to FIG. 6 and referring to the recipient user interface 604, when receiving a message from another user of the interaction system 100 that has not established a bidirectional or accepted relationship (e.g., a friend relationship) with the recipient, a “non-friend” conversation view header is again displayed, as is the case with the sender user interface 602. Specifically, the conversation view header also includes an add button 606, which is user-selectable by the recipient user to add the sending user as a friend and accordingly establish a friend relationship between the sender user and the recipient user.

As is shown in FIG. 6, the recipient user interface 604, upon receiving a message from a non-friend, also displays a set of privacy control graphical elements, including explanation text 610 with a user-selectable hide or block button 612 and a user-selectable okay button 614 button. The explanation text 610 provides an explanation, to the recipient user, of a relationship (or lack thereof) with the sending user, and provides a highly visible way for the recipient user to easily block (e.g., disable the receipt of any further communications) from the sending user. In the illustrated example, the explanation text 610 identifies the sending user as not being a friend, but invites the recipient user to nevertheless enter communications with the sending user (if the recipient chooses to do so) by selecting the okay button 614, or to block the sender by selecting the hide or block button 612. If the okay button 614 is selected, the set of privacy control graphical elements may disappear and not be presented again in respect of exchanges between the two users in question.

Accordingly, the subject user may send an electronic message to the recipient user, and the recipient user may be presented, in the messaging user interface, with a set of privacy control graphical elements providing a mechanism to allow or disallow further communications with the subject user (in other words, one or more of the privacy control graphical elements are user-selectable to allow or disallow communications with the specific user).

Example embodiments enable a user to open a “non-friend” conversation from anyone by providing or enabling several technical functionalities or features within the interaction system 100, specifically the interaction client 104. For example, an active (sending) user may attempt to open a conversation with any other registered user of the interaction system 100 that was located during a user search, and then attempt to send a message to the located user (or view a message received from the located user, if any). If the sending user has not established a bidirectional (e.g., friend) relationship with the other user, when opening the conversation, the sending user is presented with a user interface such as the sender user interface 602 (or the messaging user interface 912 as described below). The sending user may open such “non-friend” conversations from a search function, then utilize an “add friend” function or a context function.

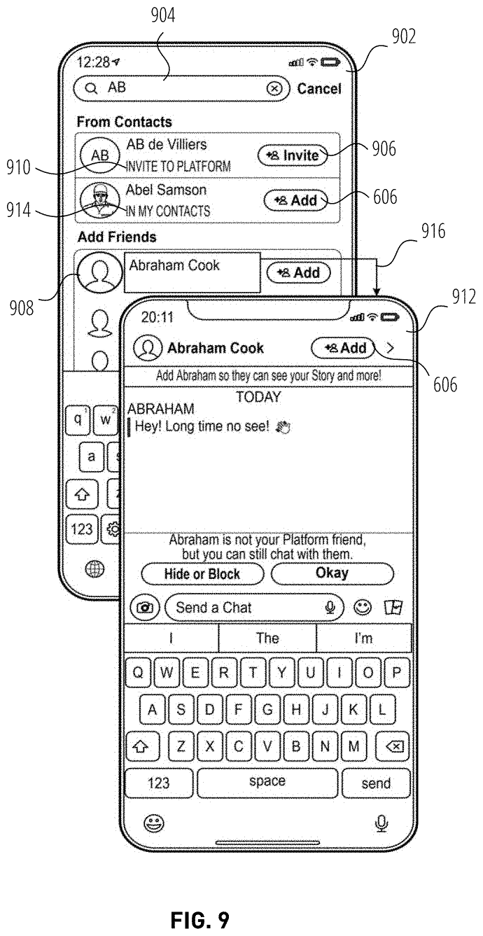

FIG. 9 illustrates an example search user interface 902, having a search bar 904 into which a textual search query may be entered by an active user of the interaction client 104. The search results are displayed in a first list of search results from contacts (e.g., results located in the active user's contact management application), and then, in the second section, a list of further search results that cannot be matched to any records within the active user's contact list.

To this end, in some examples, the interaction client 104 may access a set of electronic contact data associated with a third-party application (e.g., a contacts application or other messaging application such as email or other third-party messaging application) and perform a matching operation between the third-party electronic contact data and registered users of the interaction system 100, to identify entities (e.g., persons) that are both in the searching user's list of third-party application contacts and that are registered users of the interaction system 100. Where such a match is located (e.g., by matching email addresses or mobile telephone numbers), information regarding the relevant entities is displayed in the “from contacts” section, as shown in FIG. 9.

For entities for which contact data exists for entities (e.g., users) in the electronic contact data from a third-party application but that are not registered users of the interaction system 100, these entities are also included in the “from contacts” section, but an invitation button 906 is shown adjacent to a contact identifier (e.g., a name) for an entity. Accordingly, the search may return details of “off-platform” entities (non-users). These off-platform entities may be visually distinguished from registered users of the platform, e.g., by the invitation button 906 and the text 910 (“INVITE TO PLATFORM”) shown in FIG. 9. As a result, the active user is provided with a mechanism to easily invite the non-user to register with the interaction system 100, e.g., by selecting the presented user-selectable invitation graphical element in the example form of the invitation button 906, causing transmission of a registration invitation to a device of the non-user (e.g., using a phone number located for the user “AB de Villiers” during the search).

For an entity for which a match occurred between electronic contact data associated with the third-party application and a registered user of the interaction system 100, an add button 606 is displayed, within the search user interface 902, adjacent to a contact identifier (e.g., a name) for the matched entity. The matched entity is further identified by the words “IN MY CONTACTS” (see, for example, the text 914 included in the cell identifying the matched user “Abel Samson”).

Other registered users returned by the search, being those for which no match was found in the searching user's contacts and that do not have a direct relationship with the searching user, are displayed in the “add friends” section. Within the search user interface 902, user selection of a graphic identifier of a registered user, such as an avatar 908, invokes a conversation view by displaying a messaging user interface 912. FIG. 9 illustrates a transition 916 from the search user interface 902 to the messaging user interface 912 according to some examples. The messaging user interface 912 enables the sending user to directly message a receiving user, even though these users may not have established a one-directional or two-directional social relationship. Selection of the avatar 908 may thus invoke an interaction with a non-friend. The messaging user interface 912 further includes, as described above, an add button 606.

Further, as also alluded to above, user selection, by the sending user, of the add button 606 invokes a relationship establishment procedure, with the establishment of a one-directional relationship between the sending user and the receiving user (see the friend addition indicator 702 in FIG. 7, for example), as well as the extension of an invitation from the sending user to the receiving user to accept the relationship request and thereby establish a bidirectional relationship. The bidirectional relationship, in some examples, may include permissions to share certain information between bidirectionally related users, such as collections of media content and location information, and the ability for the two users to call each other, e.g., via the calling buttons 802. Similarly, where only a one-directional relationship is established (e.g., by a first user extending an invitation to a second user), the establishment of this relationship may include permissions to share certain information of the first user with the second user. For example, the interaction system 100, on the establishment of a one-directional relationship, may operate to automatically share certain media content, collections of media content, personal information, or location information of the first user with the second user. On acceptance of an invitation and establishing a bidirectional relationship, similar information of the second user may likewise be shared with the first user.

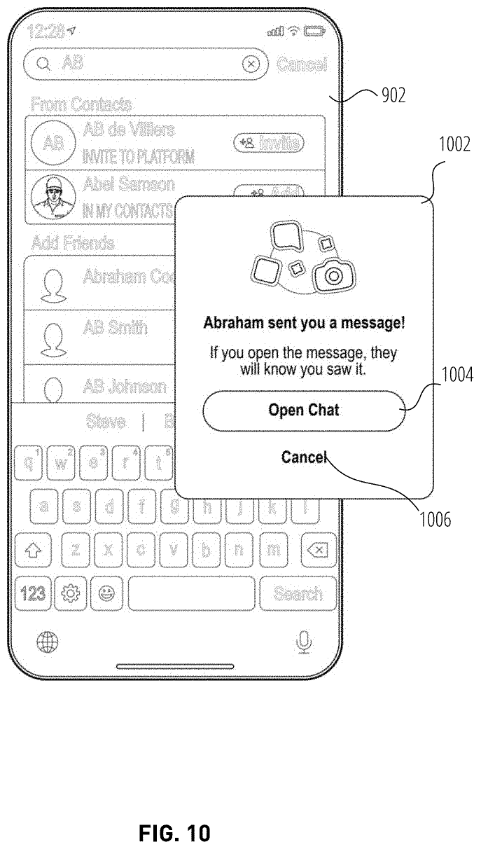

FIG. 10 is a user interface diagram showing an alert notification 1002 that may be presented to a user, according to some examples. The alert notification 1002 is presented to a user if a conversation that the user is attempting to open has certain inbound or viewed interactions, such as messages. For example, this may apply to a message transmitted by the user “Abraham Cook” as is shown in the messaging user interface 912 of FIG. 9.

The user of the interaction client 104 is presented with the alert notification 1002 before being presented with further information and content of a relevant conversation. This alert notification 1002 enables the user to make an informed choice regarding opening a conversation with a non-friend where the interaction system 100, for example, might record and communicate certain content (e.g., message content), as being “viewed” to the other user. For example, the alert notification 1002 includes text identifying the sending user and an interaction type of the sending user, together with text alerting the receiving user that the sending user will be notified if the receiving user accesses a message sent by the sending user. The alert notification 1002 then presents two options to the receiving user: a first action option to participate in the interaction, for example, viewing the message content and proceeding further with the conversation (e.g., an open chat button 1004) and a second option to dismiss the interaction (e.g., a cancel button 1006).

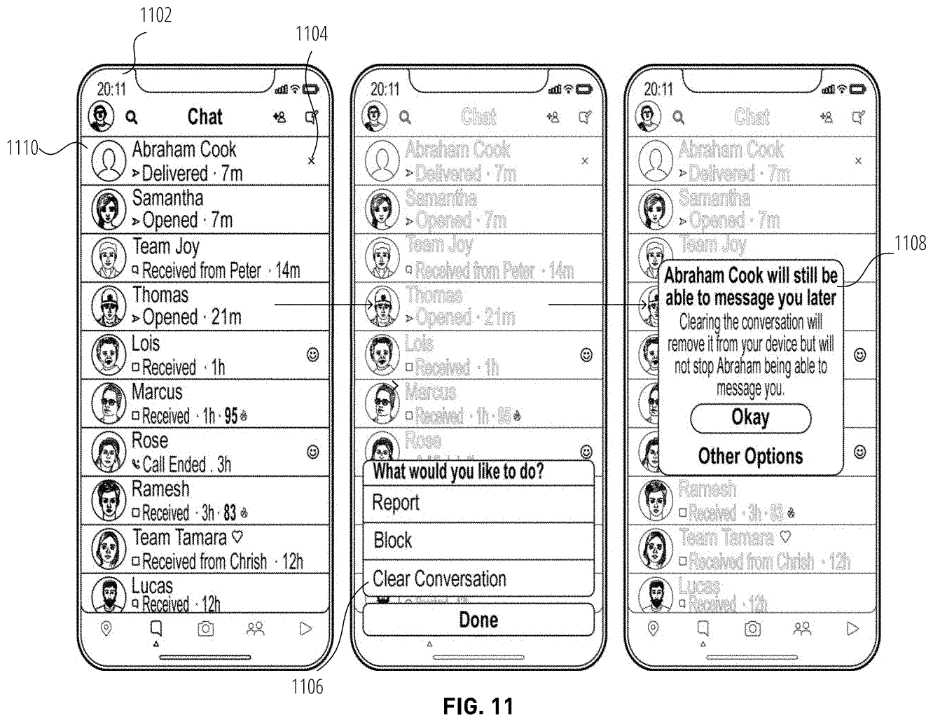

FIG. 11 is a user interface diagram illustrating an interaction or message feed interface 1102, according to some examples. The message feed interface 1102 displays a number of interactions, in the example form of messages or “chats” in which a user is involved, with the chat exchanges being displayed in a reverse-chronological sequence (with the most recent interaction shown at the top).

Where the interaction comprises sending a message to a user with which the sending user has not established a bidirectional relationship (e.g., a non-friend receiver), a feed cell corresponding to that sent message is flagged or visually distinguished, for example, using an X, which acts as a non-friend indicator. For example, the feed cell 1110 is flagged with the indicator 1104. The indicator 1104 remains presented within the message feed interface 1102 until the relevant entity (e.g., “Abraham Cook”) is recognized by the interaction system 100 as having established a bidirectional relationship with the sending user. Further, the indicator 1104 is user-selectable to hide or block the relevant entity from further communications. For example, where the feed cell is for a message delivered from the non-friend user to the viewing user, the viewing user may tap on the indicator 1104 to block any further communications from the sending user. Specifically, by tapping on the indicator 1104, a viewing user invokes an action sheet 1106 (overlaid on the message feed interface 1102) using which the viewing user can report, block, or clear the relevant conversation from the interaction feed, and accordingly the message feed interface 1102, of the viewing user.

User selection of the clear conversation option within the action sheet 1106 invokes a confirmation sheet 1108, which is displayed overlaid on the message feed interface 1102. The confirmation sheet 1108 communicates to the viewing user the actions taken as a result of selection of the clear conversation option. For example, user-selection of the clear conversation option may result in the viewing user being notified that the non-friend user, “Abraham Cook,” will still be able to message the sending user later, and that the clear conversation action has operated to remove the relevant conversation from a device of the viewing user.

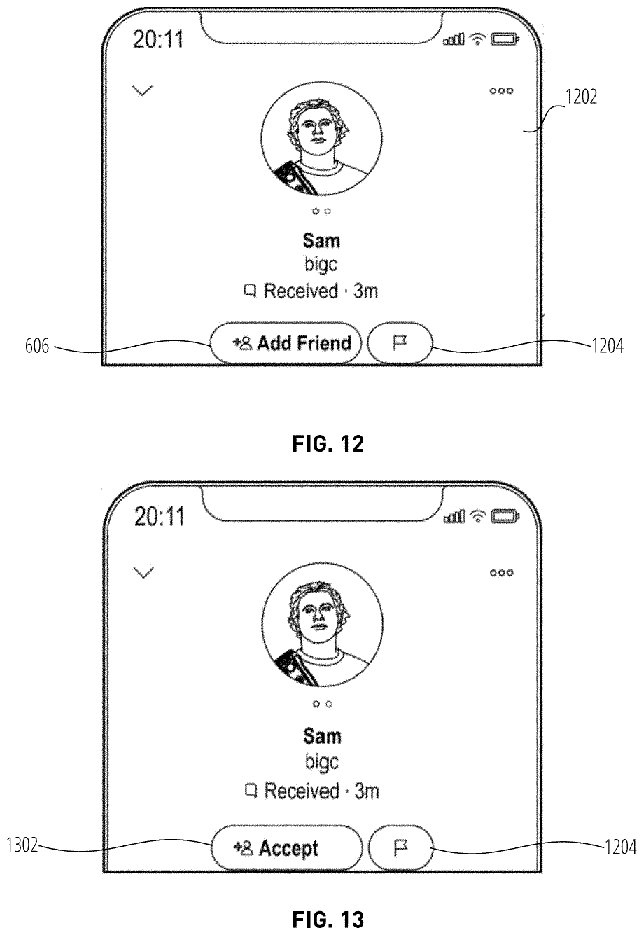

FIG. 12 is a user interface diagram showing part of a user profile interface 1202, according to some examples. The user profile interface 1202 is displayed to a viewing user, within the context of interaction client 104, for example, responsive to user selection of an appropriate cell within the search user interface 902. A user profile interface 1202 for a user of interaction system 100, with whom the viewing user has not established a relationship (either one-directional or bidirectional), may provide a profile view including certain information and functionality in addition to, or that is absent from, the profile view presented for a user with which the viewer user has a relationship. In the example illustrated in FIG. 12, an add button 606 and a reporting indicium in the form of a reporting flag 1204 are displayed within the user profile interface 1202.

Further, and as shown in FIG. 13, in the event that the non-friend user has sent a relationship request to the viewing user, an accept button 1302 is displayed within the user profile interface 1202 instead of the add button 606. The reporting flag 1204 is also displayed adjacent to the accept button 1302.

In some examples, in addition to presenting the user-selectable indicia described in FIG. 12 and FIG. 13, the user profile interface, for a non-friend user, may also omit to display specific information, such as current geographic location, shared content, or other interaction information published via the interaction system 100, associated with the user of the displayed user profile.

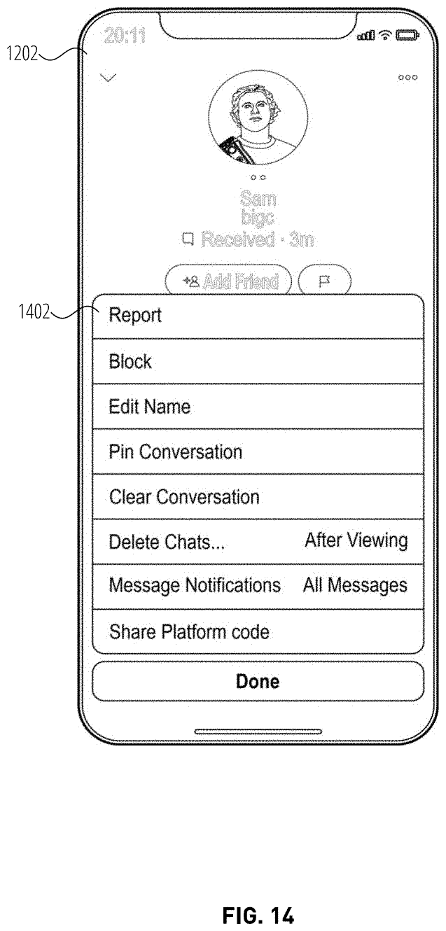

FIG. 14 is a user interface diagram showing an action sheet 1402, according to some examples, that is overlaid on the user profile interface 1202 and presents a number of actions that a viewing user may take with respect to the user profile of another user of the interaction system 100. These actions include reporting the other user, blocking the other user, editing the name of the other user in the viewing user's interaction client 104, chat settings, etc.

Example embodiments enable “non-friend” messages, which may also be referred to as “pre-friend” messages, to be surfaced in a user's message feed, also referred to as a chat feed, by providing or enabling several technical functionalities or features within the interaction system 100, specifically the interaction client 104.

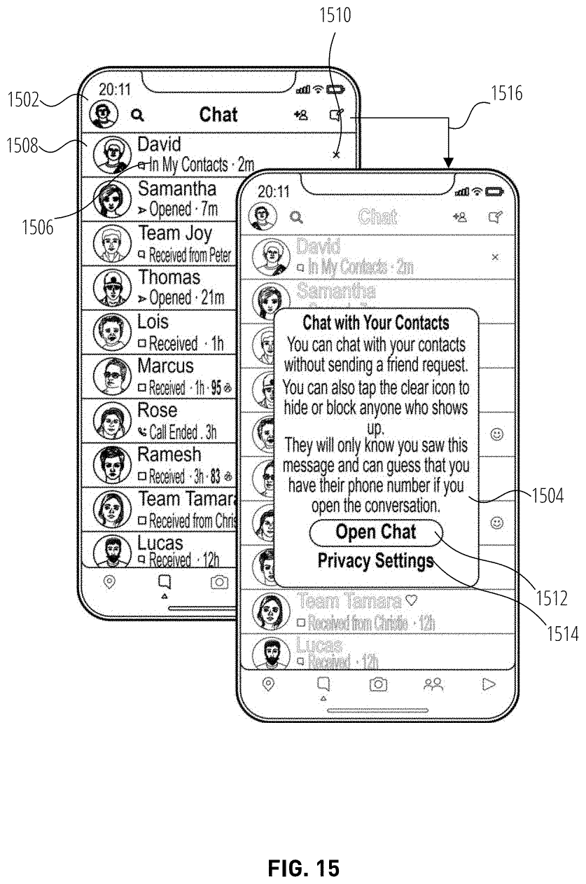

FIG. 15 is a user interface sequence diagram illustrating a message feed interface 1502 and an alert notification overlaid alert notification 1504 onto the message feed interface, according to some examples. The message feed interface 1502 displays a number of interactions, in the example form of messages or “chats” in which a user has been a participant. Each chat is identified in a dedicated, user-selectable cell, with the cells being displayed in a reverse-chronological sequence (with the most recent interaction's cell shown at the top).

In FIG. 15, the active user (in this case being a receiving user, or recipient) receives a message from another user (“David”, as shown in the top cell in FIG. 15). The receiving user and the other user do not have an established bidirectional relationship recorded in the interaction system 100, but the other user is associated with a record in the receiving user's contact management application. Accordingly, the interaction system 100 permits the other user to interact with the receiving user by way of a message, which is presented to the receiving user in the message feed interface 1502 and is visually distinguished from other messages that originate from entities with which the receiving user does have an established bidirectional relationship.

The “non-friend” message may be identified or flagged in the message feed interface 1502 by text 1506, located in a message cell 1508 identifying the interaction, indicating to the receiving user that a message has been received from an entity that is not a “friend” of the active user, but is linked to a record in the receiving user's contact management application (“In My Contacts” is displayed in the message cell 1508, as opposed to, for example, “New Chat” displayed for a message received from a “friend”). The text 1506 thus serves as a first non-friend indicator in the form of a feed cell subtext element for an inbound message. The text 1506 may disappear from the message feed interface 1502 once the receiving user has opened the relevant message.

The “non-friend” message is further flagged or visually distinguished, using an X, which acts as a second non-friend indicator 1510. The non-friend indicator 1510 may remain presented within the message feed interface 1502 until the relevant entity is recognized by the interaction system 100 as having established a bidirectional relationship with the receiving user. Further, as described above, the indicator 1104 is user-selectable by the receiving user to hide or block the relevant entity from further communications.

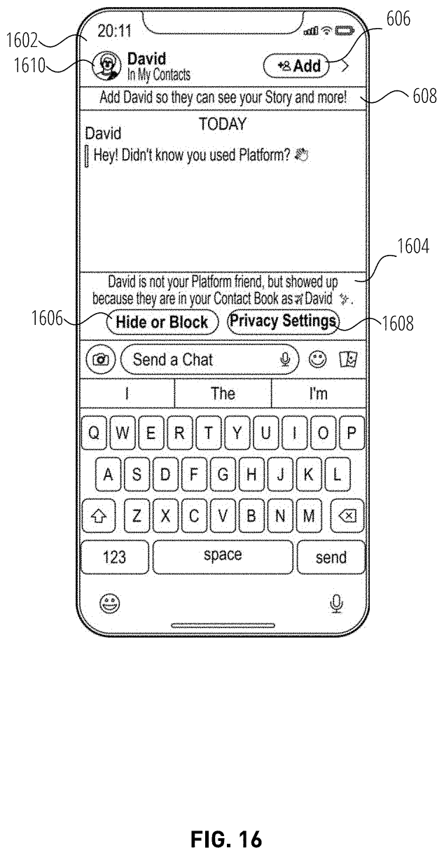

If the receiving user selects the message cell 1508, prior to opening the conversation, the interaction client 104 may transition 1516 to a state in which the alert notification 1504 is presented. The alert notification 1504 is presented to the receiving user to enable the receiving user to make an informed decision about whether to proceed with the “non-friend” messaging activity. The receiving user can then decide whether to proceed by selecting the open chat button 1512 or instead to adjust their privacy settings by selecting the privacy settings button 1514. In some examples, the alert notification 1504 may only be displayed to a new user of the interaction system 100 once, or a predetermined number of times. If the receiving user decides to interact with the other user and selects the open chat button 1512 (thus opting in to the “non-friend” messaging feature), the interaction client 104 may present a recipient user interface such as the one shown in FIG. 16.

FIG. 16 is a user interface diagram showing a recipient user interface 1602 as may be presented by the interaction client 104, according to some examples, to a user of the interaction system 100. In FIG. 16, a sender (“David”) sends a message to a non-friend user and the recipient receives the message as shown in the recipient user interface 1602, based on the interaction system 100 determining that, while the two users do not have a bidirectional relationship, the sender (“David”) is associated with a contact record in the recipient's contact management application (linked third-party application).

When the recipient opens a conversation with a non-friend, an add button 606 is presented within the header of the relevant user interface and a description bar 608 attached to the header with text that explains why the user might want to add this entity as a friend, e.g., “Add [FIRST NAME] so they can see your Story and more!”

The add button 606 is user-selectable by the recipient to add the sender as a friend and accordingly initiate establishment of a friend relationship between the users. Upon receiving a message from a non-friend, the recipient user interface 1602 also displays a set of privacy graphical elements, including explanation text 1604 together with a hide or block button 1606 and a privacy settings button 1608. The explanation text 1604 provides an explanation to the recipient of a relationship (or lack thereof) with the sender, and provides a highly visible way for the recipient to easily block (e.g., disable or hide the receipt of any further communications) from the sender.

In some examples, a specific user of the interaction system 100 is only enabled to interact with another, non-friend user, of the interaction system 100, if the privacy settings of the other user permit such interactions. For example, in response to the interaction system 100 checking a privacy setting of the other user stored within the interaction system 100 and determining that the privacy setting permits electronic interaction with users having no relationship as reflected in the relevant relationship data, the specific user can send a message to the other (non-friend) user. If the interaction system 100 detects that the privacy setting allows for such interaction (e.g., interaction with a “contact” who is not a “friend”), the interaction system 100 may cause presentation, at a device of the other user (e.g., in a messaging user interface), of an indication of the initiation of the electronic interaction by the specific user. Such an indication may, for example, be an indication as shown in FIG. 15, which, when selected, launches the interaction, e.g., as shown in the example form of a messaging conversation in FIG. 16.

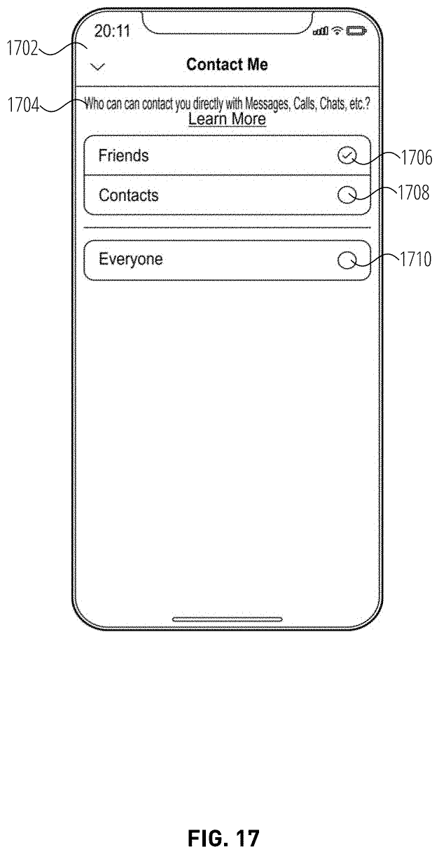

Recipient-side privacy may thus be governed by the recipient's privacy settings stored within the interaction system 100. If the recipient selects the privacy settings button 1514 or the privacy settings button 1608, for example, the interaction client 104 presents a contact settings interface 1702 that allows for user-selection of specific settings, as in FIG. 17.

The contact settings interface 1702 includes explanation text 1704, indicating to the subject user that the contact settings interface 1702 can be used to select the categories of other users of the interaction system 100 that are able to contact the user directly (in FIG. 17, this refers specifically to messaging and calling interactions).

The subject user may select a friends option element 1706. If the friends option element 1706 is selected, a friends option is enabled by the interaction system 100 for the subject user, allowing friends (users with which the subject user holds a bidirectional relationship as reflected in the relationship data) to call and send messages to the subject user directly. The subject user may select a contacts option element 1708. If selected, a contacts option is enabled by the interaction system 100, allowing non-friends that appear in the user's contact management application (e.g., contacts application 420) to send messages to the user and call the user. This may be referred to as “contact messaging” or “contact calling”, as opposed to “friend messaging” or “friend calling” respectively.

The user may select an everyone options element 1710. If selected, an “everyone can contact me” option is enabled by the interaction system 100 for the subject user, allowing any registered user of the interaction system 100 to interact directly with the subject user, irrespective of their relationship with the user (e.g., even if the other user is not a friend or contact of the subject user). If the “everyone can contact me” option is selected, the other two options in the contact settings interface 1702 are frozen and cannot be adjusted (given that the “everyone can contact me” option already covers both the friends option element 1706 and the contacts option element 1708).

If the user does not select the contacts option element 1708 or the everyone options element 1710, “non-friend” messaging will not be permitted for the subject user by the interaction system 100. In some examples, if the subject user interacts with “non-friends” and then, at a later stage, adjusts their privacy settings to no longer allow such interactions, existing conversations associated with “non-friends” are removed automatically from the subject user's message feed by the interaction system 100.

It will be appreciated that the privacy setting examples described with reference to FIG. 17 are examples only and alternative or additional privacy settings may be applied. For example, the interaction system 100 can automatically apply certain restrictions based on a user's age. Users below the age of, for example, 18 years, may be locked into a friends only option, meaning that the subject user (being younger than 18 years of age) is only able to receive messages and calls directly from another user if the subject user has a bidirectional relationship with the relevant other user. This setting may be applied even if the other user's contact details are located in the subject user's contact book and matched during the matching operation. In other words, the subject user may be prevented from selecting an option such as the contacts option element 1708 or the everyone options element 1710. As mentioned above, a sending user may still be enabled to send a message to the subject user (younger than 18 years of age), but the interaction system 100 may be configured not to make the subject user aware of the message, e.g., by not surfacing the message in a message feed interface unless the two users subsequently establish a bidirectional relationship. This feature can, in some examples, enhance user profile privacy by not enabling a sending user to deduce sensitive personal information of a (proposed) recipient.

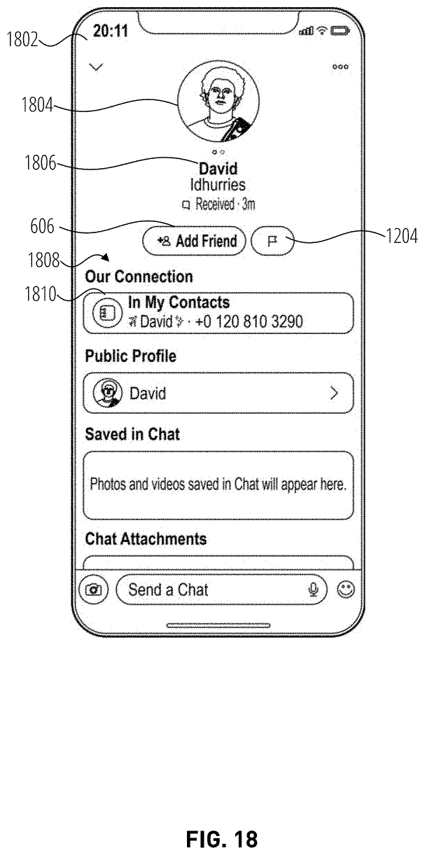

Within a conversation view, such as the recipient user interface 1602, the recipient can select a graphic identifier, such as an avatar 1610, to invoke presentation of a user profile interface for the user associated with the avatar 1610. FIG. 18 illustrates a user profile interface 1802 according to some examples.

The user profile interface 1802 displays, to the viewing user, an avatar or user image 1804 of the viewed user, a user name 1806 of the viewed user, as well as an add button 606 and a reporting flag 1204. The add button 606 is shown based on the lack of a bidirectional relationship between the viewing user and the viewed user. The user profile interface 1802 further presents a connection section 1808 providing a non-friend indicator in the form of a contact card cell 1810. The contact card cell 1810 indicates, to the viewing user, that the viewed user is not a friend of the viewing user, but the viewed user's phone number was found in the viewing user's contact management application, e.g., during a matching operation as described above (hence the descriptor “In My Contacts” being displayed).

The connection section 1808 may essentially provide the viewing user with a reason, or explanation, as to why the viewing user is able to interact with the viewed user (or vice versa) even though the two users have not established a bidirectional relationship within the interaction system 100. In some examples, in response to detecting that the viewing user has deleted the viewed user's contact details from the contact management application, the interaction system 100 causes the contact card cell 1810 to be removed automatically from the user profile interface 1802.

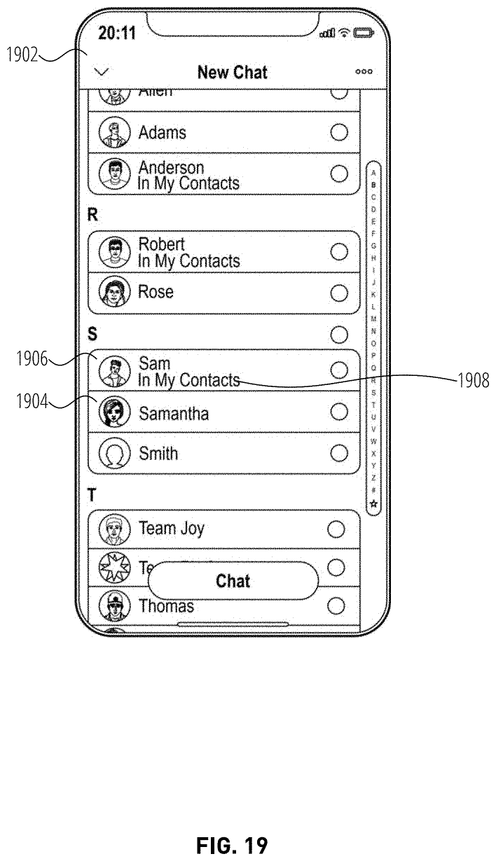

FIG. 19 is a user interface diagram illustrating a conversation creation interface, or new chat interface 1902, according to some examples. The new chat interface 1902 enables an active user to add one or more users of the interaction system 100 to a new chat. The chat may be a private exchange between only two users, or a group conversation (if, for example, the active user decides to add a plurality of users to the new chat).

In the new chat interface 1902, the active user is presented with a list of available users. The list is presented in the example form of a commingled list of contact identifiers, including contact identifiers for friends of the active user (where a bidirectional relationship exists) and contact identifiers for users who are not friends of the active user, but are associated with records found during a matching operation. As described above, the interaction client 104 may access a set of electronic contact data associated with a third-party application (e.g., a contacts application or other messaging applications such as email or other third-party messaging application) and perform a matching operation between the third-party electronic contact data and registered users of the interaction system 100, to identify entities (e.g., persons) that are both in the active user's list of third-party application contacts and that are registered users of the interaction system 100. Where such a match is located (e.g., by matching email addresses or mobile telephone numbers), identifiers for the relevant entities may be displayed in the commingled list as shown in FIG. 19.

The identifiers of the friends of the active user and the identifiers of “non-friends” of the active user are visually distinguished. In FIG. 19, this distinction is effected by way of subtext included below the name of the relevant “non-friend” user (in the same cell of the new chat interface 1902). For example, a first contact identifier 1904 is a cell identifying a user (“Samantha”) with which the active user has a bidirectional relationship, and a second contact identifier 1906 is a cell identifying a user with which the active user does not have a bidirectional relationship, but for which a matching record was found during the matching operation. Accordingly, the subtext 1908 (“In My Contacts”) is included in the cell representing the second contact identifier 1906 but not in the cell representing the first contact identifier 1904.

This may allow an active user to find a person they are already connected to in a third-party application, e.g., a contact management application or email application, but not in the interaction system 100, and initiate an interaction with them in an intuitive and easy manner, while still providing a visible distinction between such a person and “friends” of the active user. If the active user does decide to initiate a conversation with, for example, the user identified by the second contact identifier 1906 (“Sam”), messaging may be initiated using interfaces similar to those shown in FIG. 6.

In some examples, as part of a conversation creation process facilitated by the new chat interface 1902, the interaction system 100 may prevent the active user from adding both a “friend” and a “non-friend” to the same new chat. Further, and as alluded to above, the new chat interface 1902 may be adjusted or limited based on user privacy settings, user age, or the like. For example, a user who has selected a friends only contacting option may not be presented with any “non-friends” in the new chat interface 1902. Similarly, a user younger than 18 years of age may only be presented with a list of users with whom the user has a bidirectional relationship, automatically preventing the user from adding “non-friends” to a new chat.

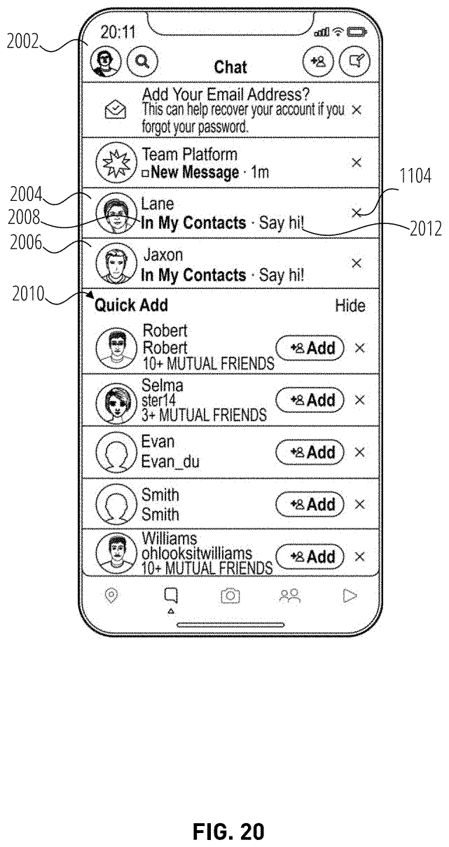

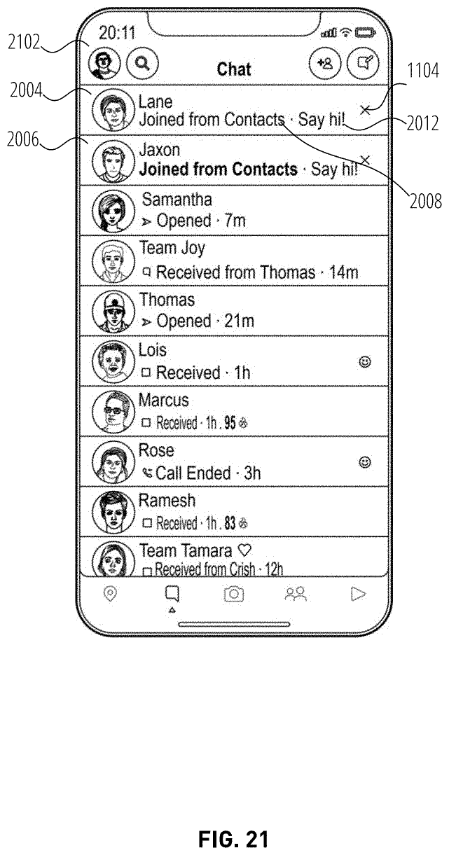

FIG. 20 and FIG. 21 are user interface diagrams illustrating message feed interfaces that include friend recommendations, according to some examples. As mentioned above, the recommendation engine 236 may generate, for a specific user, a recommendation, and such a recommendation may be surfaced in a user interface presented to the specific user, allowing the user to request establishment of a relationship with a suggested user in a convenient manner (e.g., without having to perform a search for the suggested user), or simply interact with the suggested user without requesting establishment of a relationship.

In some examples, generating composite electronic contact data as described above (e.g., including combined contact data for “friends” and “contacts” of a user) comprises determining, using output from (e.g., generated by) the recommendation engine 236, that an electronic contact record associated with a suggested user is to be included in the composite electronic contact data. In this way, a commingled list of contact identifiers can be presented to the active user, including at least one first contact identifier associated with one or more “friends” and at least one second contact identifier associated with one or more other users of the interaction system 100, who are not “friends” of the active users but are to be recommended to the active user by the interaction system 100 based on the matching operation.

Turning now more specifically to FIG. 20 and FIG. 21, a message feed interface 2002 and a message feed interface 2102 both present, to the active user, a first suggested user 2004 and a second suggested user 2006. The first suggested user 2004 and the second suggested user 2006 do not have a bidirectional relationship with the active user within the interaction system 100, but were matched with the active user during the matching operation. Specifically, the interaction system 100 determines, using the matching system 234, that each of the first suggested user 2004 and the second suggested user 2006 is associated with a respective contact in the contacts application of the active user. Accordingly, the recommendation engine 236 causes identifiers for these two suggested users to be presented to the active user, along with explanation text 2008 (“In My Contacts” or “Joined from Contacts”) and recommendation text 2012 (“Say hi!”). In this way, the active user is presented with a recommended user of the interaction system 100 to interact with and/or add as a friend, based on the interaction system 100 determining that the recommended user is a contact of the active user in a linked third-party application.

In FIG. 20, cells including identifiers for the first suggested user 2004 and the second suggested user 2006 are presented above a “Quick Add” section of the message feed interface 2002. The “Quick Add” section presents a list of other suggested users 2010 generated by the recommendation engine 236, but not including matching operation results. For example, the other suggested users 2010 can include users having friends in common with the active user (mutual friends) but that are not identified in the active user's contacts application. In FIG. 21, cells including identifiers of the first suggested user 2004 and the second suggested user 2006 are presented in the message feed interface 2102 above a conventional set of message feed cells, each identifying a conversation with a user (or group) within the interaction system 100.

As discussed above, while the text 2008 acts as a non-friend indicator, a feed cell corresponding to each suggested user may further be flagged or visually distinguished, for example, using an X, which also acts as a non-friend indicator 1104. The indicator 1104 remains presented until the relevant entity is recognized by the interaction system 100 as having established a bidirectional relationship with the active user. Further, the indicator 1104 is user-selectable by a viewing user to hide or block the relevant entity from further communications. In this case, the active user may tap on the indicator 1104 to remove the suggestion from the message feed interface 2002 and/or block/hide any communications from the suggested user.

The identifier of a suggested user may be surfaced and/or positioned relative to other contact identifiers in a user interface, e.g., in a commingled list, based on output received from the recommendation engine 236. For example, the order of suggested users in a message feed may be determined based on a time when each suggestion was generated, and the order may be dynamically updated over time as suggestions change or new suggestions are generated.

In some examples, a user of the interaction system 100 may be presented with “N” number of “non-friend messaging suggestions,” as determined by the recommendation engine 236, based on a predefined algorithm. Pseudocode illustrating process logic according to some examples, for implementing recommendations of this nature, is included below. It should be appreciated that the pseudocode included below includes plain/simple language descriptions of certain steps in an algorithm, logic and/or other process. While the pseudocode uses structural conventions resembling a programming language, it is intended for human reading rather than machine reading. It may thus omit details that are essential for machine understanding, such as variable declarations and language-specific code.

Example generation logic for a user (pseudocode):

```
  [START]
  Input: FindFriendsRegSortedSuggestions: OrderedList
  output: NonFriendMessagingResult: OrderedList
  params: PositiveNoiseRate; NegativeNoiseRate; PositiveNoiseCap;
NegativeNoiseCap; SuggestionCap
  init: SuggestListAfterNoise // skip the step for filtering by rate limiting
  and privacy
setting bidirectionalList, inMyContactsOnlyList =
splitByInMyContacts(findFriendsRegSortedSuggestions)
  var NonFriendMessagingResult<suggestion>
  foreach sug in inMyContactsOnlyList:
  if (randomByWeek < PositiveNoiseRate):
  NonFriendMessagingResult.add(sug)
  foreach sug in bidirectionalList:
  if (randomByWeek > = NegativeNoise):
  NonFriendMessagingResult.add(sug)
  sort(NonFriendMessagingResult)
  result = NonFriendMessagingResult.sublist(0, SuggestionCap)
  [END]
```

The above process, according to some examples, uses a function called “splitByInMyContacts” to split the input “findFriendsRegSortedSuggestions” into two lists: a “bidirectionalList” and an “inMyContactsOnlyList.” The process loops through each suggestion in “inMyContactsOnlyList” and adds it to the “NonFriendMessagingResult” list with a probability determined by “PositiveNoiseRate.” The process also loops through each suggestion in “bidirectionalList” and adds it to the “NonFriendMessagingResult” list with a probability determined by “NegativeNoiseRate.” The process includes sorting the “NonFriendMessagingResult” list and returning a final result in accordance with a “SuggestionCap.”

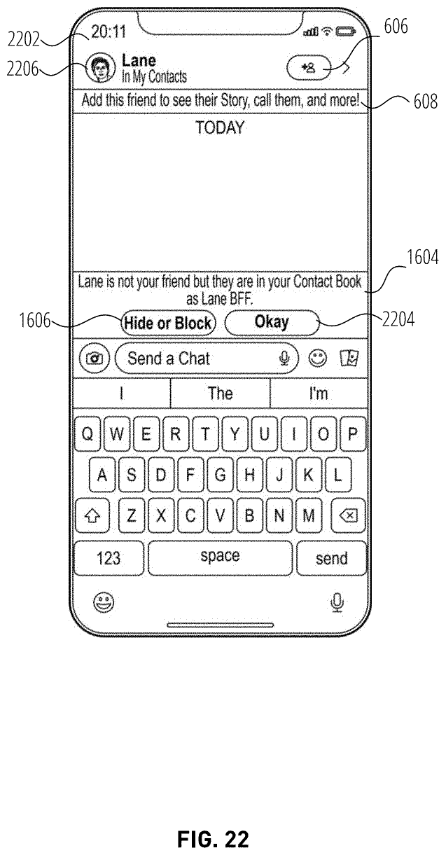

FIG. 22 is a user interface diagram showing a sender user interface 2202, according to some examples. The sender user interface 2202 may be presented to the active user in response to the active user selecting the identifier of the first suggested user 2004 shown in FIG. 21, to enable the active user to initiate a “non-friend message.”

The sender user interface 2202 includes a graphic identifier, such as an avatar 2206, which is selectable to invoke presentation of a user profile interface for the user associated with the avatar 2206. An add button 606 is presented within the header of the relevant user interface and a description bar 608 attached to the header with text that explains why the user might want to add this friend, e.g., “Add this friend to see their Story, call them, and more!”

The add button 606 is user-selectable by the active user to add the suggested user as a friend and accordingly establish a friend relationship between the users (or initiate a friend request). The sender user interface 2202 also displays a set of privacy graphical elements, including explanation text 1604 together with a hide or block button 1606 and an OK button 2204. The explanation text 1604 provides an explanation to the active user of a user relationship, and provides a highly visible way for the active user to easily block (e.g., disable the receipt of any communications or hide further communications) from the suggested user. User selection of the OK button 2204 may cause the privacy graphical elements to disappear from the sender user interface 2202.

Data Communications Architecture

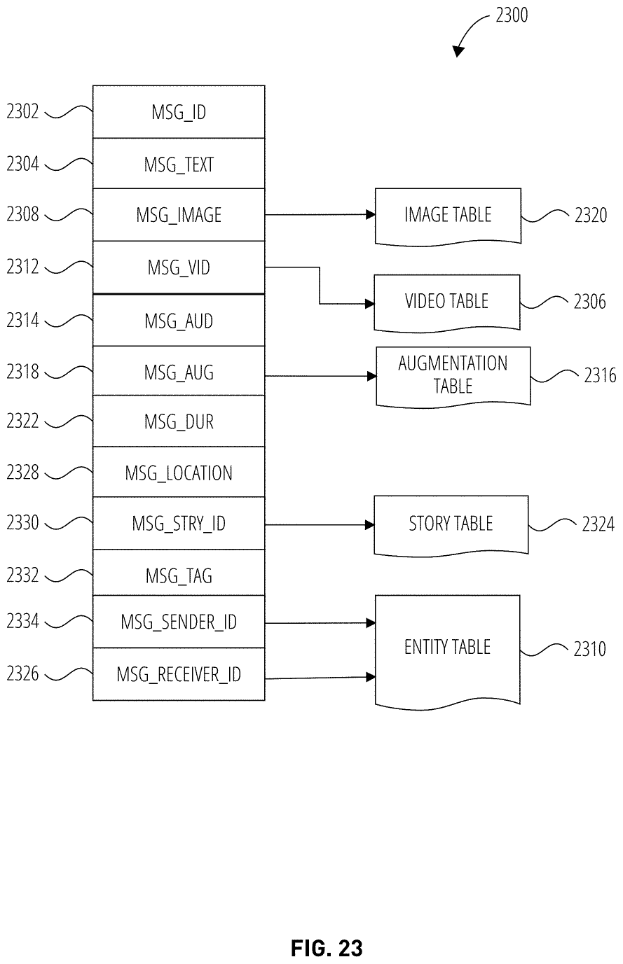

FIG. 23 is a schematic diagram illustrating a structure of a message 2300, according to some examples, generated by an interaction client 104 for communication to a further interaction client 104 via the interaction servers 118. The content of a particular message 2300 is used to populate the message table 302 stored within the database 120, accessible by the interaction servers 118. Similarly, the content of a message 2300 is stored in memory as “in-transit” or “in-flight” data of the user system 102 or the interaction servers 118. A message 2300 is shown to include the following example components:
Message identifier 2302: a unique identifier that identifies the message 2300.
Message text payload 2304: text, to be generated by a user via a user interface of the user system 102, and that is included in the message 2300.
Message image payload 2308: image data, captured by a camera component of a user system 102 or retrieved from a memory component of a user system 102, and that is included in the message 2300. Image data for a sent or received message 2300 may be stored in the image table 2320.
Message video payload 2312: video data, captured by a camera component or retrieved from a memory component of the user system 102, and that is included in the message 2300. Video data for a sent or received message 2300 may be stored in the video table 2306.
Message audio payload 2314: audio data, captured by a microphone or retrieved from a memory component of the user system 102, and that is included in the message 2300.
Message augmentation data 2318: augmentation data (e.g., filters, stickers, or other annotations or enhancements) that represents augmentations to be applied to message image payload 2308, message video payload 2312, or message audio payload 2314 of the message 2300. Augmentation data for a sent or received message 2300 may be stored in the augmentation table 2316.
Message duration parameter 2322: parameter value indicating, in seconds, the amount of time for which content of the message (e.g., the message image payload 2308, message video payload 2312, message audio payload 2314) is to be presented or made accessible to a user via the interaction client 104.
Message geolocation parameter 2328: geolocation data (e.g., latitudinal and longitudinal coordinates) associated with the content payload of the message. Multiple message geolocation parameter 2328 values may be included in the payload, each of these parameter values being associated with respect to content items included in the content (e.g., a specific image within the message image payload 2308, or a specific video in the message video payload 2312).
Message story identifier 2330: identifier values identifying one or more content collections (e.g., “stories” identified in the story table 2324) with which a particular content item in the message image payload 2308 of the message 2300 is associated. For example, multiple images within the message image payload 2308 may each be associated with multiple content collections using identifier values.
Message tag 2332: each message 2300 may be tagged with multiple tags, each of which is indicative of the subject matter of content included in the message payload. For example, where a particular image included in the message image payload 2308 depicts an animal (e.g., a lion), a tag value may be included within the message tag 2332 that is indicative of the relevant animal. Tag values may be generated manually, based on user input, or may be automatically generated using, for example, image recognition.
Message sender identifier 2334: an identifier (e.g., a messaging system identifier, email address, or device identifier) indicative of a user of the user system 102 on which the message 2300 was generated and from which the message 2300 was sent.
Message receiver identifier 2326: an identifier (e.g., a messaging system identifier, email address, or device identifier) indicative of a user of the user system 102 to which the message 2300 is addressed.

The contents (e.g., values) of the various components of message 2300 may be pointers to locations in tables within which content data values are stored. For example, an image value in the message image payload 2308 may be a pointer to (or address of) a location within an image table 2320. Similarly, values within the message video payload 2312 may point to data stored within a video table 2306, values stored within the message augmentation data 2318 may point to data stored in an augmentation table 2316, values stored within the message story identifier 2330 may point to data stored in a story table 2324, and values stored within the message sender identifier 2334 and the message receiver identifier 2326 may point to user records stored within an entity table 2310.

Time-Based Access Limitation Architecture

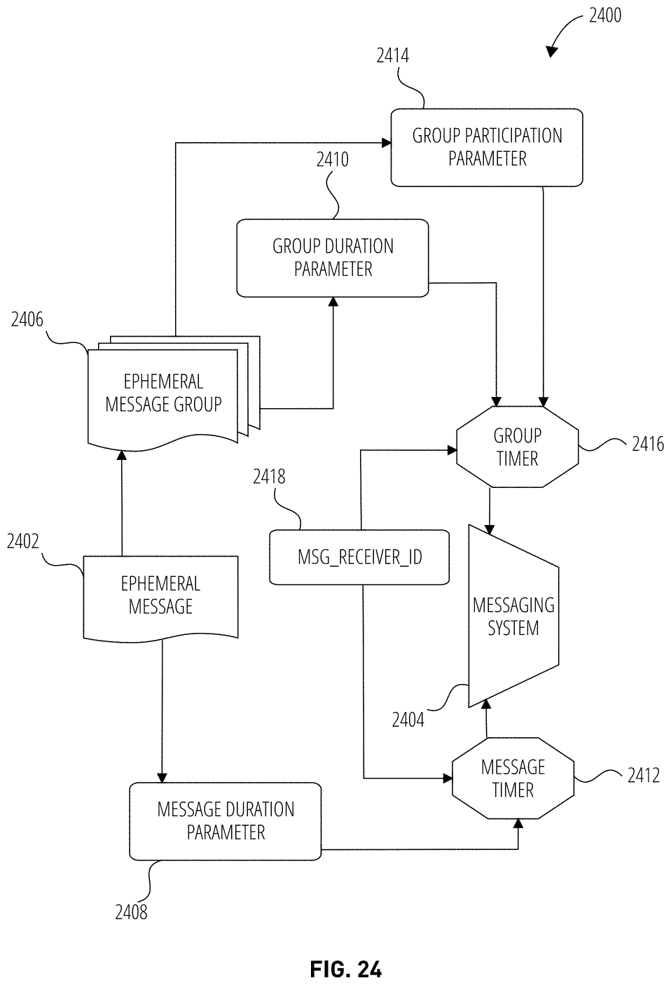

FIG. 24 is a schematic diagram illustrating an access-limiting process 2400, in terms of which access to content (e.g., an ephemeral message 2402 and associated multimedia payload of data) or a content collection (e.g., an ephemeral message group 2406) may be time-limited (e.g., made ephemeral).

An ephemeral message 2402 is shown to be associated with a message duration parameter 2408, the value of which determines the amount of time that the ephemeral message 2402 will be displayed to a receiving user of the ephemeral message 2402 by the interaction client 104. In some examples, an ephemeral message 2402 is viewable by a receiving user for up to a maximum of 10 seconds, depending on the amount of time that the sending user specifies using the message duration parameter 2408.

The message duration parameter 2408 and the message receiver identifier 2418 are shown to be inputs to a message timer 2412, which is responsible for determining the amount of time that the ephemeral message 2402 is shown to a particular receiving user identified by the message receiver identifier 2418. In particular, the ephemeral message 2402 will be shown to the relevant receiving user for a time period determined by the value of the message duration parameter 2408. The message timer 2412 is shown to provide output to a more generalized messaging system 2404, which is responsible for the overall timing of display of content (e.g., an ephemeral message 2402) to a receiving user.

The ephemeral message 2402 is shown in FIG. 24 to be included within an ephemeral message group 2406 (e.g., a collection of messages in a personal story, or an event story). The ephemeral message group 2406 has an associated group duration parameter 2410, a value of which determines a time duration for which the ephemeral message group 2406 is presented and accessible to users of the interaction system 100. The group duration parameter 2410, for example, may be the duration of a music concert, where the ephemeral message group 2406 is a collection of content pertaining to that concert. Alternatively, a user (either the owning user or a curator user) may specify the value for the group duration parameter 2410 when performing the setup and creation of the ephemeral message group 2406.

Additionally, each ephemeral message 2402 within the ephemeral message group 2406 has an associated group participation parameter 2414, a value of which determines the duration of time for which the ephemeral message 2402 will be accessible within the context of the ephemeral message group 2406. Accordingly, a particular ephemeral message group 2406 may “expire” and become inaccessible within the context of the ephemeral message group 2406, prior to the ephemeral message group 2406 itself expiring in terms of the group duration parameter 2410. The group duration parameter 2410, group participation parameter 2414, and message receiver identifier 2418 each provide input to a group timer 2416, which operationally determines, firstly, whether a particular ephemeral message 2402 of the ephemeral message group 2406 will be displayed to a particular receiving user and, if so, for how long. Note that the ephemeral message group 2406 is also aware of the identity of the particular receiving user as a result of the message receiver identifier 2418.

Accordingly, the group timer 2416 operationally controls the overall lifespan of an associated ephemeral message group 2406, as well as an individual ephemeral message 2402 included in the ephemeral message group 2406. In some examples, each and every ephemeral message 2402 within the ephemeral message group 2406 remains viewable and accessible for a time period specified by the group duration parameter 2410. In a further example, a certain ephemeral message 2402 may expire within the context of ephemeral message group 2406, based on a group participation parameter 2414. Note that a message duration parameter 2408 may still determine the duration of time for which a particular ephemeral message 2402 is displayed to a receiving user, even within the context of the ephemeral message group 2406. Accordingly, the message duration parameter 2408 determines the duration of time that a particular ephemeral message 2402 is displayed to a receiving user, regardless of whether the receiving user is viewing that ephemeral message 2402 inside or outside the context of an ephemeral message group 2406.

The messaging system 2404 may furthermore operationally remove a particular ephemeral message 2402 from the ephemeral message group 2406 based on a determination that it has exceeded an associated group participation parameter 2414. For example, when a sending user has established a group participation parameter 2414 of 24 hours from posting, the messaging system 2404 will remove the relevant ephemeral message 2402 from the ephemeral message group 2406 after the specified 24 hours. The messaging system 2404 also operates to remove an ephemeral message group 2406 when either the group participation parameter 2414 for each and every ephemeral message 2402 within the ephemeral message group 2406 has expired, or when the ephemeral message group 2406 itself has expired in terms of the group duration parameter 2410.

In certain use cases, a creator of a particular ephemeral message group 2406 may specify an indefinite group duration parameter 2410. In this case, the expiration of the group participation parameter 2414 for the last remaining ephemeral message 2402 within the ephemeral message group 2406 will determine when the ephemeral message group 2406 itself expires. In this case, a new ephemeral message 2402, added to the ephemeral message group 2406, with a new group participation parameter 2414, effectively extends the life of an ephemeral message group 2406 to equal the value of the group participation parameter 2414.

Responsive to the messaging system 2404 determining that an ephemeral message group 2406 has expired (e.g., is no longer accessible), the messaging system 2404 communicates with the interaction system 100 (and, for example, specifically the interaction client 104) to cause an indicium (e.g., an icon) associated with the relevant ephemeral message group 2406 to no longer be displayed within a user interface of the interaction client 104. Similarly, when the messaging system 2404 determines that the message duration parameter 2408 for a particular ephemeral message 2402 has expired, the messaging system 2404 causes the interaction client 104 to no longer display an indicium (e.g., an icon or textual identification) associated with the ephemeral message 2402.

System with Head-Wearable Apparatus

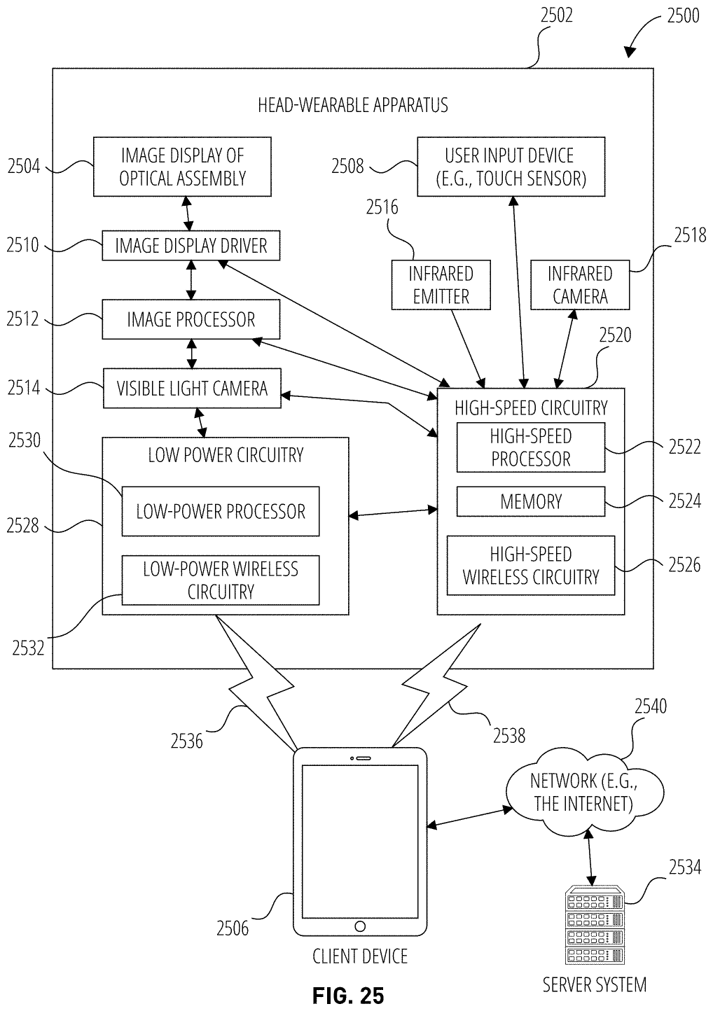

FIG. 25 illustrates a system 2500 including a head-wearable apparatus 2502 with a selector input device, according to some examples. FIG. 25 is a high-level functional block diagram of an example head-wearable apparatus 2502 communicatively coupled with a mobile client device 2506 and a server system 2534 via various network 2540.

Head-wearable apparatus 2502 includes a camera, such as at least one of visible light camera 2514, infrared emitter 2516, and infrared camera 2518.

Client device 2506 can be capable of connecting with head-wearable apparatus 2502 using both a low-power wireless connection 2536 and a high-speed wireless connection 2538. Client device 2506 is connected to server system 2534 and network 2540. The network 2540 may include any combination of wired and wireless connections.

Head-wearable apparatus 2502 further includes two image displays of the image display of optical assembly 2504. The two image displays of optical assembly 2504 include one associated with the left lateral side and one associated with the right lateral side of the head-wearable apparatus 2502. Head-wearable apparatus 2502 also includes image display driver 2510, image processor 2512, low power circuitry 2528, and high-speed circuitry 2520. Image display of optical assembly 2504 is for presenting images and videos, including an image that can include a graphical user interface to a user of the head-wearable apparatus 2502.

Image display driver 2510 commands and controls the image display of optical assembly 2504. Image display driver 2510 may deliver image data directly to the image display of optical assembly 2504 for presentation or may have to convert the image data into a signal or data format suitable for delivery to the image display device. For example, the image data may be video data formatted according to compression formats, such as H. 264 (MPEG-4 Part 10), HEVC, Theora, Dirac, RealVideo RV40, VP8, VP9, or the like, and still image data may be formatted according to compression formats such as Portable Network Group (PNG), Joint Photographic Experts Group (JPEG), Tagged Image File Format (TIFF) or exchangeable image file format (Exif) or the like.

The head-wearable apparatus 2502 includes a frame and stems (or temples) extending from a lateral side of the frame. Head-wearable apparatus 2502 further includes a user input device 2508 (e.g., touch sensor or push button) including an input surface on the head-wearable apparatus 2502. The user input device 2508 (e.g., touch sensor or push button) is to receive from the user an input selection to manipulate the graphical user interface of the presented image.

The components shown in FIG. 25 for the head-wearable apparatus 2502 are located on one or more circuit boards, for example a PCB or flexible PCB, in the rims or temples. Alternatively, or additionally, the depicted components can be located in the chunks, frames, hinges, or bridge of the head-wearable apparatus 2502. Left and right visible light cameras 2514 can include digital camera elements such as a complementary metal-oxide-semiconductor (CMOS) image sensor, charge-coupled device, camera lenses, or any other respective visible or light-capturing elements that may be used to capture data, including images of scenes with unknown objects.

Head-wearable apparatus 2502 includes a memory 2524, which stores instructions to perform a subset or all of the functions described herein. Memory 2524 can also include storage devices. As shown in FIG. 25, high-speed circuitry 2520 includes high-speed processor 2522, memory 2524, and high-speed wireless circuitry 2526. In the example, the image display driver 2510 is coupled to the high-speed circuitry 2520 and operated by the high-speed processor 2522 in order to drive the left and right image displays of the image display of optical assembly 2504. High-speed processor 2522 may be any processor capable of managing high-speed communications and operation of any general computing system needed for head-wearable apparatus 2502. High-speed processor 2522 includes processing resources needed for managing high-speed data transfers on high-speed wireless connection 2538 to a wireless local area network (WLAN) using high-speed wireless circuitry 2526. In certain examples, the high-speed processor 2522 executes an operating system such as a LINUX operating system or other such operating system of the head-wearable apparatus 2502, and the operating system is stored in memory 2524 for execution. In addition to any other responsibilities, the high-speed processor 2522 executing a software architecture for the head-wearable apparatus 2502 is used to manage data transfers with high-speed wireless circuitry 2526. In certain examples, high-speed wireless circuitry 2526 is configured to implement Institute of Electrical and Electronic Engineers (IEEE) 802.11 communication standards, also referred to herein as WiFi. In some examples, other high-speed communications standards may be implemented by high-speed wireless circuitry 2526.

Low-power wireless circuitry 2532 and the high-speed wireless circuitry 2526 of the head-wearable apparatus 2502 can include short range transceivers (Bluetooth™) and wireless wide, local, or wide area network transceivers (e.g., cellular or WiFi). Client device 2506, including the transceivers communicating via the low-power wireless connection 2536 and high-speed wireless connection 2538, may be implemented using details of the architecture of the head-wearable apparatus 2502, as can other elements of network 2540.

Memory 2524 includes any storage device capable of storing various data and applications, including, among other things, camera data generated by the left and right visible light cameras 2514, infrared camera 2518, and the image processor 2512, as well as images generated for display by the image display driver 2510 on the image displays of the image display of optical assembly 2504. While memory 2524 is shown as integrated with high-speed circuitry 2520, in some examples, memory 2524 may be an independent standalone element of the head-wearable apparatus 2502. In certain such examples, electrical routing lines may provide a connection through a chip that includes the high-speed processor 2522 from the image processor 2512 or low-power processor 2530 to the memory 2524. In some examples, the high-speed processor 2522 may manage addressing of memory 2524 such that the low-power processor 2530 will boot the high-speed processor 2522 any time that a read or write operation involving memory 2524 is needed.

As shown in FIG. 25, the low-power processor 2530 or high-speed processor 2522 of the head-wearable apparatus 2502 can be coupled to the camera (visible light camera 2514; infrared emitter 2516, or infrared camera 2518), the image display driver 2510, the user input device 2508 (e.g., touch sensor or push button), and the memory 2524.

Head-wearable apparatus 2502 is connected with a host computer. For example, the head-wearable apparatus 2502 is paired with the client device 2506 via the high-speed wireless connection 2538 or connected to the server system 2534 via the network 2540. Server system 2534 may be one or more computing devices as part of a service or network computing system, for example, that includes a processor, a memory, and network communication interface to communicate over the network 2540 with the client device 2506 and head-wearable apparatus 2502.

The client device 2506 includes a processor and a network communication interface coupled to the processor. The network communication interface allows for communication over the network 2540, low-power wireless connection 2536, or high-speed wireless connection 2538. Client device 2506 can further store at least portions of the instructions for generating a binaural audio content in the client device 2506's memory to implement the functionality described herein.

Output components of the head-wearable apparatus 2502 include visual components, such as a display such as a liquid crystal display (LCD), a plasma display panel (PDP), a light-emitting diode (LED) display, a projector, or a waveguide. The image displays of the optical assembly are driven by the image display driver 2510. The output components of the head-wearable apparatus 2502 further include acoustic components (e.g., speakers), haptic components (e.g., a vibratory motor), other signal generators, and so forth. The input components of the head-wearable apparatus 2502, the client device 2506, and server system 2534, such as the user input device 2508, may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or other pointing instruments), tactile input components (e.g., a physical button, a touch screen that provides location and force of touches or touch gestures, or other tactile input components), audio input components (e.g., a microphone), and the like.

Head-wearable apparatus 2502 may optionally include additional peripheral device elements. Such peripheral device elements may include biometric sensors, additional sensors, or display elements integrated with head-wearable apparatus 2502. For example, peripheral device elements may include any I/O components including output components, motion components, position components, or any other such elements described herein.

For example, the biometric components include components to detect expressions (e.g., hand expressions, facial expressions, vocal expressions, body gestures, or eye-tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components include acceleration sensor components (e.g., accelerometer), gravitation sensor components, rotation sensor components (e.g., gyroscope), and so forth. The position components include location sensor components to generate location coordinates (e.g., a Global Positioning System (GPS) receiver component), Wi-Fi or Bluetooth™ transceivers to generate positioning system coordinates, altitude sensor components (e.g., altimeters or barometers that detect air pressure from which altitude may be derived), orientation sensor components (e.g., magnetometers), and the like. Such positioning system coordinates can also be received over low-power wireless connections 2536 and high-speed wireless connection 2538 from the client device 2506 via the low-power wireless circuitry 2532 or high-speed wireless circuitry 2526.

Where a phrase similar to “at least one of A, B, or C,” “at least one of A, B, and C,” “one or more A, B, or C,” or “one or more of A, B, and C” is used, it is intended that the phrase be interpreted to mean that A alone may be present in an example, B alone may be present in an example, C alone may be present in an example, or that any combination of the elements A, B and C may be present in a single example; for example, A and B, A and C, B and C, or A and B and C.

Changes and modifications may be made to the disclosed examples without departing from the scope of the present disclosure. These and other changes or modifications are intended to be included within the scope of the present disclosure, as expressed in the following claims.

Software Architecture

FIG. 26 is a block diagram 2600 illustrating a software architecture 2604, which can be installed on any one or more of the devices described herein. The software architecture 2604 is supported by hardware such as a machine 2602 that includes processors 2620, memory 2626, and I/O components 2636. In this example, the software architecture 2604 can be conceptualized as a stack of layers, where each layer provides a particular functionality. The software architecture 2604 includes layers such as an operating system 2612, libraries 2610, frameworks 2608, and applications 2606. Operationally, the applications 2606 invoke API calls 2648 through the software stack and receive messages 2650 in response to the API calls 2648.

The operating system 2612 manages hardware resources and provides common services. The operating system 2612 includes, for example, a kernel 2614, services 2616, and drivers 2622. The kernel 2614 acts as an abstraction layer between the hardware and the other software layers. For example, the kernel 2614 provides memory management, processor management (e.g., scheduling), component management, networking, and security settings, among other functionalities. The services 2616 can provide other common services for the other software layers. The drivers 2622 are responsible for controlling or interfacing with the underlying hardware. For instance, the drivers 2622 can include display drivers, camera drivers, BLUETOOTH® or BLUETOOTH® Low Energy drivers, flash memory drivers, serial communication drivers (e.g., USB drivers), WI-FI® drivers, audio drivers, power management drivers, and so forth.

The libraries 2610 provide a common low-level infrastructure used by the applications 2606. The libraries 2610 can include system libraries 2618 (e.g., C standard library) that provide functions such as memory allocation functions, string manipulation functions, mathematical functions, and the like. In addition, the libraries 2610 can include API libraries 2624 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., WebKit to provide web browsing functionality), and the like. The libraries 2610 can also include a wide variety of other libraries 2628 to provide many other APIs to the applications 2606.

The frameworks 2608 provide a common high-level infrastructure that is used by the applications 2606. For example, the frameworks 2608 provide various graphical user interface (GUI) functions, high-level resource management, and high-level location services. The frameworks 2608 can provide a broad spectrum of other APIs that can be used by the applications 2606, some of which may be specific to a particular operating system or platform.

In an example, the applications 2606 may include a home application 2634, a contacts application 420, a browser application 2630, a book reader application 2632, a location application 2640, a media application 2642, a messaging application 2644, a game application 2646, and a broad assortment of other applications such as a third-party application 2638. The applications 2606 are programs that execute functions defined in the programs. Various programming languages can be employed to create one or more of the applications 2606, structured in a variety of manners, such as object-oriented programming languages (e.g., Objective-C, Java, or C++) or procedural programming languages (e.g., C or assembly language). In a specific example, the third-party application 2638 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 2638 can invoke the API calls 2648 provided by the operating system 2612 to facilitate functionalities described herein.

Machine Architecture

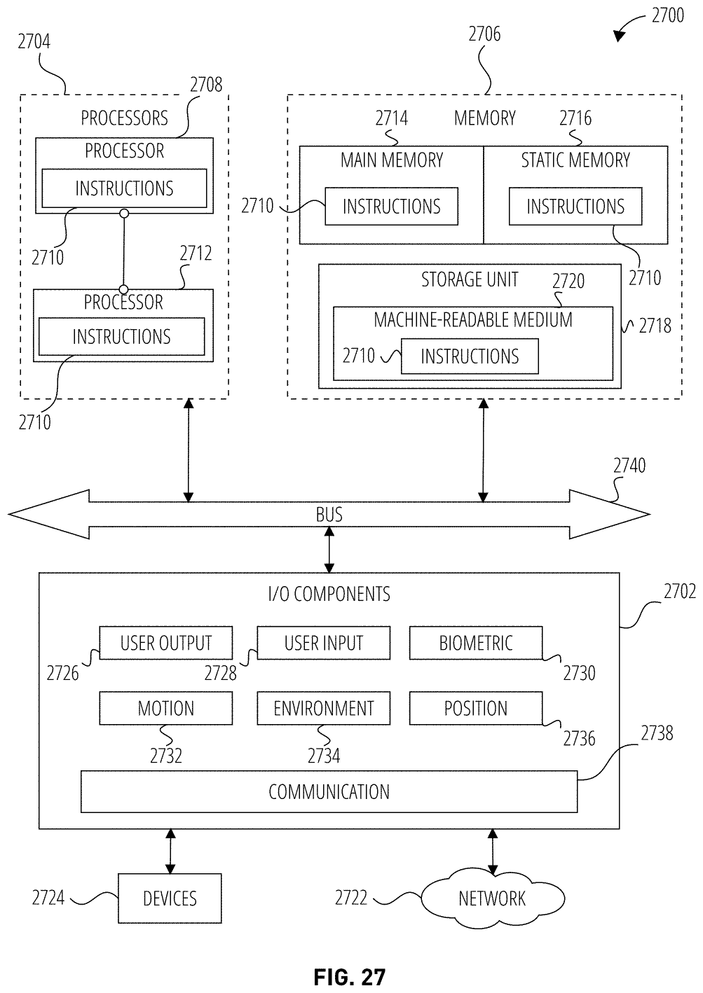

FIG. 27 is a diagrammatic representation of the machine 2700 within which instructions 2710 (e.g., software, a program, an application, an applet, an app, or other executable code) for causing the machine 2700 to perform any one or more of the methodologies discussed herein may be executed. For example, the instructions 2710 may cause the machine 2700 to execute any one or more of the methods described herein. The instructions 2710 transform the general, non-programmed machine 2700 into a particular machine 2700 programmed to carry out the described and illustrated functions in the manner described. The machine 2700 may operate as a standalone device or may be coupled (e.g., networked) to other machines. In a networked deployment, the machine 2700 may operate in the capacity of a server machine or a client machine in a server-client network environment, or as a peer machine in a peer-to-peer (or distributed) network environment. The machine 2700 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smartphone, a mobile device, a wearable device (e.g., a smartwatch), a smart home device (e.g., a smart appliance), other smart devices, a web appliance, a network router, a network switch, a network bridge, or any machine capable of executing the instructions 2710, sequentially or otherwise, that specify actions to be taken by the machine 2700. Further, while a single machine 2700 is illustrated, the term “machine” shall also be taken to include a collection of machines that individually or jointly execute the instructions 2710 to perform any one or more of the methodologies discussed herein. The machine 2700, for example, may comprise the user system 102 or any one of multiple server devices forming part of the interaction server system 108. In some examples, the machine 2700 may also comprise both client and server systems, with certain operations of a particular method or algorithm being performed on the server-side and with certain operations of the particular method or algorithm being performed on the client-side.

The machine 2700 may include processors 2704, memory 2706, and input/output I/O components 2702, which may be configured to communicate with each other via a bus 2740. In an example, the processors 2704 (e.g., a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, a processor 2708 and a processor 2712 that execute the instructions 2710. The term “processor” is intended to include multi-core processors that may comprise two or more independent processors (sometimes referred to as “cores”) that may execute instructions contemporaneously. Although FIG. 27 shows multiple processors 2704, the machine 2700 may include a single processor with a single-core, a single processor with multiple cores (e.g., a multi-core processor), multiple processors with a single core, multiple processors with multiples cores, or any combination thereof.

The memory 2706 includes a main memory 2714, a static memory 2716, and a storage unit 2718, both accessible to the processors 2704 via the bus 2740. The main memory 2706, the static memory 2716, and storage unit 2718 store the instructions 2710 embodying any one or more of the methodologies or functions described herein. The instructions 2710 may also reside, completely or partially, within the main memory 2714, within the static memory 2716, within machine-readable medium 2720 within the storage unit 2718, within at least one of the processors 2704 (e.g., within the processor's cache memory), or any suitable combination thereof, during execution thereof by the machine 2700.

The I/O components 2702 may include a wide variety of components to receive input, provide output, produce output, transmit information, exchange information, capture measurements, and so on. The specific I/O components 2702 that are included in a particular machine will depend on the type of machine. For example, portable machines such as mobile phones may include a touch input device or other such input mechanisms, while a headless server machine will likely not include such a touch input device. It will be appreciated that the I/O components 2702 may include many other components that are not shown in FIG. 27. In various examples, the I/O components 2702 may include user output components 2726 and user input components 2728. The user output components 2726 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The user input components 2728 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and force of touches or touch gestures, or other tactile input components), audio input components (e.g., a microphone), and the like.

In further examples, the I/O components 2702 may include biometric components 2730, motion components 2732, environmental components 2734, or position components 2736, among a wide array of other components. For example, the biometric components 2730 include components to detect expressions (e.g., hand expressions, facial expressions, vocal expressions, body gestures, or eye-tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 2732 include acceleration sensor components (e.g., accelerometer), gravitation sensor components, rotation sensor components (e.g., gyroscope). Any biometric data collected by biometric components is captured and stored with only user approval and deleted on user request. Further, such biometric data may be used for very limited purposes, such as identification verification. To ensure limited and authorized use of biometric information and other personally identifiable information (PII), access to this data is restricted to authorized personnel only, if at all. Any use of biometric data may strictly be limited to identification verification purposes, and the biometric data is not shared or sold to any third party without the explicit consent of the user. In addition, appropriate technical and organizational measures are implemented to ensure the security and confidentiality of this sensitive information.

The environmental components 2734 include, for example, one or cameras (with still image/photograph and video capabilities), illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment.

With respect to cameras, the user system 102 may have a camera system comprising, for example, front cameras on a front surface of the user system 102 and rear cameras on a rear surface of the user system 102. The front cameras may, for example, be used to capture still images and video of a user of the user system 102 (e.g., “selfies”), which may then be augmented with augmentation data (e.g., filters) described above. The rear cameras may, for example, be used to capture still images and videos in a more traditional camera mode, with these images similarly being augmented with augmentation data. In addition to front and rear cameras, the user system 102 may also include a 360° camera for capturing 360° photographs and videos.

Further, the camera system of the user system 102 may include dual rear cameras (e.g., a primary camera as well as a depth-sensing camera), or even triple, quad or penta rear camera configurations on the front and rear sides of the user system 102. These multiple camera systems may include a wide camera, an ultra-wide camera, a telephoto camera, a macro camera, and a depth sensor, for example.

The position components 2736 include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 2702 further include communication components 2738 operable to couple the machine 2700 to a network 2722 or devices 2724 via respective coupling or connections. For example, the communication components 2738 may include a network interface Component or another suitable device to interface with the network 2722. In further examples, the communication components 2738 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 2724 may be another machine or any of a wide variety of peripheral devices (e.g., a peripheral device coupled via a USB).

Moreover, the communication components 2738 may detect identifiers or include components operable to detect identifiers. For example, the communication components 2738 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D barcode, and other optical codes), or acoustic detection components (e.g., microphones to identify tagged audio signals). In addition, a variety of information may be derived via the communication components 2738, such as location via Internet Protocol (IP) geolocation, location via Wi-Fi® signal triangulation, location via detecting an NFC beacon signal that may indicate a particular location, and so forth.

The various memories (e.g., main memory 2714, static memory 2716, and memory of the processors 2704) and storage unit 2718 may store one or more sets of instructions and data structures (e.g., software) embodying or used by any one or more of the methodologies or functions described herein. These instructions (e.g., the instructions 2710), when executed by processors 2704, cause various operations to implement the disclosed examples.

The instructions 2710 may be transmitted or received over the network 2722, using a transmission medium, via a network interface device (e.g., a network interface component included in the communication components 2738) and using any one of several well-known transfer protocols (e.g., hypertext transfer protocol (HTTP)). Similarly, the instructions 2710 may be transmitted or received using a transmission medium via a coupling (e.g., a peer-to-peer coupling) to the devices 2724.

### Examples

In view of the above-described implementations of subject matter this application discloses the following list of examples, wherein one feature of an example in isolation or more than one feature of an example, taken in combination and, optionally, in combination with one or more features of one or more further examples are further examples also falling within the disclosure of this application.

Example 1 is a method comprising: maintaining, for an interaction system: first electronic contact data for a plurality of users of the interaction system, and relationship data relating to relationships between the plurality of users of the interaction system; using the first electronic contact data and the relationship data, automatically generating composite electronic contact data including: a first electronic contact record for a first user of the interaction system with which a specific user of the interaction system has a relationship as reflected in the relationship data, and a second electronic contact record for a second user of the interaction system with which the specific user has no relationship as reflected in the relationship data; causing presentation of the composite electronic contact data within the interaction system, wherein the presentation of the composite electronic contact data comprises visually distinguishing presentation of the first electronic contact record from presentation of the second electronic contact record; and enabling the specific user of the interaction system to initiate an electronic interaction with the second user using the second electronic contact record.

In Example 2, the subject matter of Example 1 includes, wherein the generating of the composite electronic contact data comprises: accessing second electronic contact data, the second electronic contact data being associated with a third-party application; performing a matching operation between the first electronic contact data and the second electronic contact data; and including the second electronic contact data within the composite electronic contact data based on determining a match between an electronic data record in the second electronic contact data and the second electronic contact record.

In Example 3, the subject matter of Examples 1-2 includes, wherein the causing presentation of the composite electronic contact data within the interaction system comprises causing presentation, in a user interface, of a commingled list of contact identifiers including a first contact identifier for the first user and a second contact identifier for the second user.

In Example 4, the subject matter of Example 3 includes, wherein the presentation of the commingled list comprises visually distinguishing the first contact identifier from the second contact identifier within the commingled list.

In Example 5, the subject matter of Example 4 includes, wherein the second contact identifier comprises a non-friend indicator and the first contact identifier does not comprise the non-friend indicator.

In Example 6, the subject matter of Examples 1-5 includes, wherein the relationship data records a bidirectional relationship, within the interaction system, between the specific user and the first user.

In Example 7, the subject matter of Examples 1-6 includes, wherein the enabling of the specific user to initiate the electronic interaction with the second user comprises enabling the specific user to send an electronic message to the second user of the interaction system associated with the second electronic contact record.

In Example 8, the subject matter of Example 7 includes, wherein the electronic message is an electronic message presented to the second user, in a messaging user interface, including a set of privacy control graphical elements, one or more of the privacy control graphical elements being user-selectable to allow or disallow communications with the specific user.

In Example 9, the subject matter of Examples 7-8 includes, wherein the enabling of the specific user to send the electronic message to the second user comprises causing presentation of a messaging user interface including a relationship establishing graphical element, the relationship establishing graphical element being user-selectable to invite the second user to establish a bidirectional relationship with the specific user within a context of the interaction system.

In Example 10, the subject matter of Example 9 includes, wherein the establishment of the bidirectional relationship includes enabling automatic sharing of predetermined data between the specific user and the second user, within the interaction system.

In Example 11, the subject matter of Examples 9-10 includes, wherein inviting the second user to establish the bidirectional relationship with the specific user within the context of the interaction system comprises inviting the second user to establish a bidirectional relationship in terms of which the interaction system automatically shares user-generated content between the specific user and the second user.

In Example 12, the subject matter of Examples 2-11 includes, accessing third electronic contact data, the third electronic contact data being associated with the third-party application, and the third electronic contact data including a third electronic contact record for a non-user of the interaction system; causing presentation of the third electronic contact record together with the composite electronic contact data within the interaction system, wherein the presentation of the third electronic contact record comprises visually distinguishing presentation of the third electronic contact record from both the first electronic contact record and the second electronic contact record; and enabling the specific user of the interaction system to invite the non-user to register with the interaction system using the third electronic contact record.

In Example 13, the subject matter of Example 12 includes, wherein enabling the specific user of the interaction system to invite the non-user to register with the interaction system comprises causing presentation, in a user interface, of a user-selectable invitation graphical element in association with the third electronic contact record, user selection of the invitation graphical element causing transmission of a registration invitation to a device of the non-user.

In Example 14, the subject matter of Examples 2-13 includes, wherein the third-party application is a contact management application.

In Example 15, the subject matter of Examples 2-14 includes, wherein the third-party application is a third-party communication application.

In Example 16, the subject matter of Examples 2-15 includes, wherein the third-party application is an application hosted on a device of at least one of: the specific user, the first user, or the second user.

In Example 17, the subject matter of Examples 1-16 includes, wherein the enabling of the specific user of the interaction system to initiate the electronic interaction with the second user comprises: checking a privacy setting of the second user stored within the interaction system; and responsive to determining that the privacy setting of the second user permits electronic interaction with users having no relationship as reflected in the relationship data with the second user, automatically causing presentation, at a device of the second user and within a messaging user interface, of an indication of the initiation of the electronic interaction by the specific user.

In Example 18, the subject matter of Examples 1-17 includes, wherein the generating of the composite electronic contact data comprises determining, using output generated by a recommendation engine of the interaction system, that the second electronic contact record is to be included in the composite electronic contact data, and wherein the causing presentation of the composite electronic contact data within the interaction system comprises automatically causing presentation, in a user interface, of a commingled list of contact identifiers including a first contact identifier for the first user and a second contact identifier for the second user, the second contact identifier being positioned relative to other contact identifiers in the commingled list based on the output generated by the recommendation engine.

Example 19 is a computing apparatus including at least one processor and a memory storing instructions configured such that, when executed in cooperation with controlling the at least one processor, the instructions operate the apparatus to perform operations comprising: maintaining, for an interaction system: first electronic contact data for a plurality of users of the interaction system, and relationship data relating to relationships between the plurality of users of the interaction system; using the first electronic contact data and the relationship data, automatically generating composite electronic contact data including: a first electronic contact record for a first user of the interaction system with which a specific user of the interaction system has a relationship as reflected in the relationship data, and a second electronic contact record for a second user of the interaction system with which the specific user has no relationship as reflected in the relationship data; causing presentation of the composite electronic contact data within the interaction system, wherein the presentation of the composite electronic contact data comprises visually distinguishing presentation of the first electronic contact record from presentation of the second electronic contact record; and enabling the specific user of the interaction system to initiate an electronic interaction with the second user using the second electronic contact record.

Example 20 is a non-transitory computer-readable storage medium, the computer-readable storage medium including instructions that when executed by at least one computer, cause the least one computer to perform operations comprising: maintaining, for an interaction system: first electronic contact data for a plurality of users of the interaction system, and relationship data relating to relationships between the plurality of users of the interaction system; using the first electronic contact data and the relationship data, automatically generating composite electronic contact data including: a first electronic contact record for a first user of the interaction system with which a specific user of the interaction system has a relationship as reflected in the relationship data, and a second electronic contact record for a second user of the interaction system with which the specific user has no relationship as reflected in the relationship data; causing presentation of the composite electronic contact data within the interaction system, wherein the presentation of the composite electronic contact data comprises visually distinguishing presentation of the first electronic contact record from presentation of the second electronic contact record; and enabling the specific user of the interaction system to initiate an electronic interaction with the second user using the second electronic contact record.

Example 21 is at least one machine-readable medium including instructions that, when executed by processing circuitry, cause the processing circuitry to perform operations to implement any of Examples 1-20. Example 22 is an apparatus comprising means to implement any of Examples 1-20. Example 23 is a system to implement any of Examples 1-20. Example 24 is a method to implement any of Examples 1-20.

### CONCLUSION

In some examples, first electronic contact data for a plurality of users of an interaction system, and relationship data relating to relationships between the plurality of users of the interaction system, are maintained within or by the interaction system. The first electronic contact data and the relationship data may be used to automatically generate composite electronic contact data. The composite electronic contact data may include a first electronic contact record for a first user of the interaction system with which a specific user has a relationship as reflected in the relationship data, and a second electronic contact record for a second user of the interaction system with which the specific user has no relationship as reflected in the relationship data. The composite electronic contact data is caused to be presented within the interaction system. The composite electronic contact data may be presented in such a way as to visually distinguish presentation of the first electronic contact record from presentation of the second electronic contact record. The specific user is enabled to initiate an electronic interaction with the second user using the second electronic contact record.

The interaction system may access second electronic contact data associated with a third-party application and perform a matching operation between the first electronic contact data and the second electronic contact data. Based on determining a match between an electronic data record in the second electronic contact data and the second electronic contact record, the interaction system may automatically include the second electronic contact data within the composite electronic contact data.

The interaction system may access third electronic contact data associated with the third-party application and including a third electronic contact record for a non-user of the interaction system. The third electronic contact record may be caused to be presented together with the composite electronic contact data within the interaction system. This process may include visually distinguishing presentation of the third electronic contact record from both the first electronic contact record and the second electronic contact record. The specific user of the interaction system may be enabled to invite the non-user to register with the interaction system, e.g., by presenting a user-selectable invitation graphical element in association with the third electronic contact record, providing a mechanism to cause transmission of a registration invitation to a device of the non-user (in other words, user selection of the invitation graphical element may cause transmission of a registration invitation to a device of the non-user).

Accordingly, an example technical problem of a user being unable to interact, or restricted from interactions, due to the lack of an existing (direct) relationship within an interaction system, can be addressed or alleviated by examples described herein. An example technical problem of improving the efficiency or intuitiveness of an interaction system may also be addressed or alleviated. Example methods and systems described herein provide various technological functions and safeguards that may enhance user protections and privacy.

As used in this disclosure, phrases of the form “at least one of an A, a B, or a C,” “at least one of A, B, or C,” “at least one of A, B, and C,” and the like, should be interpreted to select at least one from the group that comprises “A, B, and C.” Unless explicitly stated otherwise in connection with a particular instance in this disclosure, this manner of phrasing does not mean “at least one of A, at least one of B, and at least one of C.” As used in this disclosure, the example “at least one of an A, a B, or a C,” would cover any of the following selections: {A}, {B}, {C}, {A, B}, {A, C}, {B, C}, and {A, B, C}.

Unless the context clearly requires otherwise, throughout the description and the claims, the words “comprise,” “comprising,” and the like are to be construed in an inclusive sense, as opposed to an exclusive or exhaustive sense, i.e., in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words using the singular or plural number may also include the plural or singular number respectively. The word “or” in reference to a list of two or more items, covers all of the following interpretations of the word: any one of the items in the list, all of the items in the list, and any combination of the items in the list. Likewise, the term “and/or” in reference to a list of two or more items, covers all of the following interpretations of the word: any one of the items in the list, all of the items in the list, and any combination of the items in the list.

Although some examples, e.g., those depicted in the drawings, include a particular sequence of operations, the sequence may be altered without departing from the scope of the present disclosure. For example, some of the operations depicted may be performed in parallel or in a different sequence that does not materially affect the functions as described in the examples. In other examples, different components of an example device or system that implements an example method may perform functions at substantially the same time or in a specific sequence.

### Glossary

“Carrier signal” refers to any intangible medium that is capable of storing, encoding, or carrying instructions for execution by the machine and includes digital or analog communications signals or other intangible media to facilitate communication of such instructions. Instructions may be transmitted or received over a network using a transmission medium via a network interface device.

“Client device”, or “user device”, refers to a machine that interfaces to a network to obtain resources from one or more server systems or other client devices. A client device may be, but is not limited to, a mobile phone, desktop computer, laptop, portable digital assistants (PDAs), smartphones, tablets, ultrabooks, netbooks, laptops, multi-processor systems, microprocessor-based or programmable consumer electronics, game consoles, set-top boxes, or any other communication device that a user may use to access a network.

“Communication network” refers to one or more portions of a network that may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, a network or a portion of a network may include a wireless or cellular network, and the coupling may be a Code Division Multiple Access (CDMA) connection, a Global System for Mobile communications (GSM) connection, or other types of cellular or wireless coupling. In this example, the coupling may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth-generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long-range protocols, or other data transfer technology.

“Component” refers to a device, physical entity, or logic having boundaries defined by function or subroutine calls, branch points, APIs, or other technologies that provide for the partitioning or modularization of particular processing or control functions. Components may be composite via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components. A “hardware component” is a tangible unit capable of performing certain operations and may be configured or arranged in a certain physical manner. In various examples, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations. A hardware component may be a special-purpose processor, such as a field-programmable gate array (FPGA) or an application-specific integrated circuit (ASIC). A hardware component may also include programmable logic or circuitry that is temporarily configured by software to perform certain operations. For example, a hardware component may include software executed by a general-purpose processor or other programmable processors. Once configured by such software, hardware components become specific machines (or specific components of a machine) uniquely tailored to perform the configured functions and are no longer general-purpose processors. It will be appreciated that the decision to implement a hardware component mechanically, in dedicated and permanently configured circuitry, or in temporarily configured circuitry (e.g., configured by software), may be driven by cost and time considerations. Accordingly, the phrase “hardware component” (or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering examples in which hardware components are temporarily configured (e.g., programmed), each of the hardware components need not be configured or instantiated at any one instance in time. For example, where a hardware component comprises a general-purpose processor configured by software to become a special-purpose processor, the general-purpose processor may be configured as respectively different special-purpose processors (e.g., comprising different hardware components) at different times. Software accordingly configures a particular processor or processors, for example, to constitute a particular hardware component at one instance of time and to constitute a different hardware component at a different instance of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In examples in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information). The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” refers to a hardware component implemented using one or more processors. Similarly, the methods described herein may be at least partially processor-implemented, with a particular processor or processors being an example of hardware. For example, at least some of the operations of a method may be performed by one or more processors or processor-implemented components. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API). The performance of certain of the operations may be distributed among the processors, not only residing within a single machine, but deployed across a number of machines. In some examples, the processors or processor-implemented components may be located in a single geographic location (e.g., within a home environment, an office environment, or a server farm). In other examples, the processors or processor-implemented components may be distributed across a number of geographic locations.

“Computer-readable storage medium” refers to both machine-storage media and transmission media. Thus, the terms include both storage devices/media and carrier waves/modulated data signals. The terms “machine-readable medium,” “computer-readable medium” and “device-readable medium” mean the same thing and may be used interchangeably in this disclosure.

“Ephemeral message” refers to a message that is accessible for a time-limited duration. An ephemeral message may be a text, an image, a video and the like. The access time for the ephemeral message may be set by the message sender. Alternatively, the access time may be a default setting or a setting specified by the recipient. Regardless of the setting technique, the message is transitory.

“Machine storage medium” refers to a single or multiple storage devices and media (e.g., a centralized or distributed database, and associated caches and servers) that store executable instructions, routines and data. The term shall accordingly be taken to include, but not be limited to, solid-state memories, and optical and magnetic media, including memory internal or external to processors. Specific examples of machine-storage media, computer-storage media and device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks The terms “machine-storage medium,” “device-storage medium,” “computer-storage medium” mean the same thing and may be used interchangeably in this disclosure. The terms “machine-storage media,” “computer-storage media,” and “device-storage media” specifically exclude carrier waves, modulated data signals, and other such media, at least some of which are covered under the term “signal medium.”

“Non-transitory computer-readable storage medium” refers to a tangible medium that is capable of storing, encoding, or carrying the instructions for execution by a machine.

“Signal medium” refers to any intangible medium that is capable of storing, encoding, or carrying the instructions for execution by a machine and includes digital or analog communications signals or other intangible media to facilitate communication of software or data. The term “signal medium” shall be taken to include any form of a modulated data signal, carrier wave, and so forth. The term “modulated data signal” means a signal that has one or more of its characteristics set or changed in such a manner as to encode information in the signal. The terms “transmission medium” and “signal medium” mean the same thing and may be used interchangeably in this disclosure.

What is claimed is:

1. A method comprising:
maintaining, for an interaction system:
first electronic contact data for a plurality of users of the interaction system, and
relationship data relating to relationships between the plurality of users of the interaction system;
using the first electronic contact data and the relationship data, automatically generating composite electronic contact data including:
a first electronic contact record for a first user of the interaction system with which a specific user of the interaction system has a relationship as reflected in the relationship data, and
a second electronic contact record for a second user of the interaction system with which the specific user has no relationship as reflected in the relationship data;
causing presentation of the composite electronic contact data within the interaction system, wherein the presentation of the composite electronic contact data comprises visually distinguishing presentation of the first electronic contact record from presentation of the second electronic contact record; and
enabling the specific user of the interaction system to initiate an electronic interaction with the second user using the second electronic contact record.

2. The method of claim 1, wherein the generating of the composite electronic contact data comprises:
accessing second electronic contact data, the second electronic contact data being associated with a third-party application;
performing a matching operation between the first electronic contact data and the second electronic contact data; and
including the second electronic contact data within the composite electronic contact data based on determining a match between an electronic data record in the second electronic contact data and the second electronic contact record.

3. The method of claim 1, wherein the causing presentation of the composite electronic contact data within the interaction system comprises causing presentation, in a user interface, of a commingled list of contact identifiers including a first contact identifier for the first user and a second contact identifier for the second user.

4. The method of claim 3, wherein the presentation of the commingled list comprises visually distinguishing the first contact identifier from the second contact identifier within the commingled list.

5. The method of claim 4, wherein the second contact identifier comprises a non-friend indicator and the first contact identifier does not comprise the non-friend indicator.

6. The method of claim 1, wherein the relationship data records a bidirectional relationship, within the interaction system, between the specific user and the first user.

7. The method of claim 1, wherein the enabling of the specific user to initiate the electronic interaction with the second user comprises enabling the specific user to send an electronic message to the second user of the interaction system associated with the second electronic contact record.

8. The method of claim 7, wherein the electronic message is an electronic message presented to the second user, in a messaging user interface, including a set of privacy control graphical elements, one or more of the privacy control graphical elements being user-selectable to allow or disallow communications with the specific user.

9. The method of claim 7, wherein the enabling of the specific user to send the electronic message to the second user comprises causing presentation of a messaging user interface including a relationship establishing graphical element, the relationship establishing graphical element being user-selectable to invite the second user to establish a bidirectional relationship with the specific user within a context of the interaction system.

10. The method of claim 9, wherein the establishment of the bidirectional relationship includes enabling automatic sharing of predetermined data between the specific user and the second user, within the interaction system.

11. The method of claim 9, wherein inviting the second user to establish the bidirectional relationship with the specific user within the context of the interaction system comprises inviting the second user to establish a bidirectional relationship in terms of which the interaction system automatically shares user-generated content between the specific user and the second user.

12. The method of claim 2, further comprising:
accessing third electronic contact data, the third electronic contact data being associated with the third-party application, and the third electronic contact data including a third electronic contact record for a non-user of the interaction system;
causing presentation of the third electronic contact record together with the composite electronic contact data within the interaction system, wherein the presentation of the third electronic contact record comprises visually distinguishing presentation of the third electronic contact record from both the first electronic contact record and the second electronic contact record; and
enabling the specific user of the interaction system to invite the non-user to register with the interaction system using the third electronic contact record.

13. The method of claim 12, wherein enabling the specific user of the interaction system to invite the non-user to register with the interaction system comprises causing presentation, in a user interface, of a user-selectable invitation graphical element in association with the third electronic contact record, user selection of the invitation graphical element causing transmission of a registration invitation to a device of the non-user.

14. The method of claim 2, wherein the third-party application is a contact management application.

15. The method of claim 2, wherein the third-party application is a third-party communication application.

16. The method of claim 2, wherein the third-party application is an application hosted on a device of at least one of: the specific user, the first user, or the second user.

17. The method of claim 1, wherein the enabling of the specific user of the interaction system to initiate the electronic interaction with the second user comprises:
checking a privacy setting of the second user stored within the interaction system; and
responsive to determining that the privacy setting of the second user permits electronic interaction with users having no relationship as reflected in the relationship data with the second user, automatically causing presentation, at a device of the second user and within a messaging user interface, of an indication of the initiation of the electronic interaction by the specific user.

18. The method of claim 1, wherein the generating of the composite electronic contact data comprises determining, using output generated by a recommendation engine of the interaction system, that the second electronic contact record is to be included in the composite electronic contact data, and wherein the causing presentation of the composite electronic contact data within the interaction system comprises automatically causing presentation, in a user interface, of a commingled list of contact identifiers including a first contact identifier for the first user and a second contact identifier for the second user, the second contact identifier being positioned relative to other contact identifiers in the commingled list based on the output generated by the recommendation engine.

19. A computing apparatus including at least one processor and a memory storing instructions configured such that, when executed in cooperation with controlling the at least one processor, the instructions operate the apparatus to perform operations comprising:
maintaining, for an interaction system:
first electronic contact data for a plurality of users of the interaction system, and
relationship data relating to relationships between the plurality of users of the interaction system;
using the first electronic contact data and the relationship data, automatically generating composite electronic contact data including:
a first electronic contact record for a first user of the interaction system with which a specific user of the interaction system has a relationship as reflected in the relationship data, and
a second electronic contact record for a second user of the interaction system with which the specific user has no relationship as reflected in the relationship data;
causing presentation of the composite electronic contact data within the interaction system, wherein the presentation of the composite electronic contact data comprises visually distinguishing presentation of the first electronic contact record from presentation of the second electronic contact record; and
enabling the specific user of the interaction system to initiate an electronic interaction with the second user using the second electronic contact record.

20. A non-transitory computer-readable storage medium, the computer-readable storage medium including instructions that when executed by at least one computer, cause the least one computer to perform operations comprising:
maintaining, for an interaction system:
first electronic contact data for a plurality of users of the interaction system, and
relationship data relating to relationships between the plurality of users of the interaction system;
using the first electronic contact data and the relationship data, automatically generating composite electronic contact data including:
a first electronic contact record for a first user of the interaction system with which a specific user of the interaction system has a relationship as reflected in the relationship data, and
a second electronic contact record for a second user of the interaction system with which the specific user has no relationship as reflected in the relationship data;
causing presentation of the composite electronic contact data within the interaction system, wherein the presentation of the composite electronic contact data comprises visually distinguishing presentation of the first electronic contact record from presentation of the second electronic contact record; and
enabling the specific user of the interaction system to initiate an electronic interaction with the second user using the second electronic contact record.
